(19) United States
(12) Patent Application Publication
(10) Pub. No.: US 2024/0230373 A1
(43) Pub. Date: Jul. 11, 2024

(54) METHODS AND SYSTEMS FOR A MOBILE SMART METER AND A SMART METER OUTLET

(71) Applicant: Commonwealth Edison Company, Chicago, IL (US)

(72) Inventor: Irfan Khan, Chicago, IL (US)

(21) Appl. No.: 18/409,966

(22) Filed: Jan. 11, 2024

Related U.S. Application Data
(60) Provisional application No. 63/629,949, filed on Jan. 11, 2023.

(51) Int. Cl. G01D 4/00; B60L 53/16; B60L 53/62; B60L 53/66; G06Q 20/26; G06Q 30/04; G06Q 50/06

(52) U.S. Cl. CPC G01D 4/004; B60L 53/16; B60L 53/62; B60L 53/665; G06Q 30/04; G06Q 50/06; G01D 2204/20; G06Q 20/26

(57) ABSTRACT

Methods, systems, and apparatuses are described for using a portable smart meter configured to connect an electric vehicle (EV) to an outlet at a service location associated with a service owner in order to charge or discharge a battery of the EV. The portable smart meter may be further configured to determine an amount of energy used to charge the battery of the EV, or the amount of energy discharged from the battery, via the outlet at the service location in order to bill an owner of the EV based on the amount of energy used to charge the battery instead of the service owner or credit the owner of the EV based on the amount of energy discharged from the battery.

### CROSS REFERENCE TO RELATED PATENT APPLICATION

This Application claims priority to U.S. Non-Provisional Application No. 63/629,949, filed Jan. 11, 2023, which is herein incorporated by reference in its entirety.

### BACKGROUND

Electric vehicle (EV) deployment has steadily increased in recent years. The global EV forecast is predicted to be a compound annual growth rate of 29 percent. With EVs expected to secure approximately 32 percent of the total market share for new car sales, EV owners require easy access to a charging infrastructure. Traditional means of charging require EV owners to visit a charging station and connect their vehicle to the charger. Traditionally, the power consumption of a residential or commercial property is billed to the account associated with the revenue meter that is electrically connected to the load. EV owners would benefit from the ability to charge their vehicles using a portable, personally owned charger & infrastructure (i.e. 120 VAC or 240 VAC outlets) that is widely available in the public and private domain. However, there is currently no method to determine the amount of energy consumed by charging the EV's battery and charge the owner of the EV instead of the owner of the outlet used to charge the EV's battery. Moreover, conventional charging adapters are only configured for uni-directional power flow for charging the EV's battery and are not configured for bi-directional power flow for discharging the EV's battery allowing the owner of the EV to sell energy to the utility grid.

### SUMMARY

It is understood that both the following general description and the following detailed description are exemplary and explanatory only and are not restrictive.

Methods, systems, and apparatuses are described for a smart adapter (e.g., mobile smart meter, smart charging adapter, etc.) that may be used to connect an EV to an outlet (e.g., smart outlet, smart meter outlet, secure outlet, etc.) in order to charge a battery of the EV and bill the owner of EV for the amount of energy consumed to charge the battery instead of the owner of the outlet (e.g., service owner) used to charge the EV. In addition, the smart adapter may be configured to enable the battery to be discharged in order to provide power back on to a utility grid (e.g., vehicle to go (V2G)) and credit the owner of the EV for the amount of energy discharged by the battery to the utility grid. The smart adapter may communicate with a smart meter associated with the outlet. If a smart meter is unavailable, the smart adapter may attempt to communicate with the outlet to obtain the service owner's account information via short-range communication (e.g., Near Field Communication, or Bluetooth). If a secure outlet is not being used and/or the service owner's account information is unavailable, the smart adapter may record the location information to reconcile the billing information offline. Once the charging/discharging session has completed, the smart adapter may send the account information associated with the EV owner and the service owner to a Utility Billing System (e.g., billing network) via available communication protocols. However, if no communication protocols are available, the smart adapter may store a transaction record associated with the energy consumed to charge the battery, or the energy discharged from the battery, for upload to the network once communication protocols become available.

In an embodiment, are methods comprising receiving, by a device, user information indicative of a user account associated with the device, determining, based on the device engaging an outlet, a condition associated with an ability to communicate with a billing network, determining, based on the user information and the condition, usage information associated with charging or discharging a battery via the outlet, and sending the usage information to the billing network.

In an embodiment, are methods comprising receiving, by a device, user information indicative of a user account associated with the device, determining, based on the device engaging an outlet, a condition associated with an ability to communicate with a billing network, determining, based not satisfying the condition, an ability to communicate with a first network, determining, based on the user information and the ability to communicate with the first network, usage information associated with charging or discharging a battery via the outlet, and sending the usage information to the billing network.

In an embodiment, are methods comprising receiving, by a device, user information indicative of a user account associated with the device, determining, based on the device engaging an outlet, a condition associated with an ability to communicate with a billing network, determining, based on not satisfying the condition, an ability to communicate with a first network, determining, based on the user information and the ability to communicate with the first network, usage information associated with charging or discharging a battery via the outlet, and storing the usage information.

In an embodiment, are methods comprising receiving, by a computing device, user information indicative of a user account associated with the computing device, determining a condition associated with an ability to communicate with a billing network, determining, based on the user information and the condition, usage information associated with charging or discharging a battery via an outlet, and sending the usage information to the billing network.

In an embodiment, are methods comprising receiving, by a computing device, user information indicative of a user account associated with the computing device, determining a condition associated with an ability to communicate with a billing network, determining, based on the user information and the condition, usage information associated with charging or discharging a battery via an outlet, and storing the usage information.

In an embodiment, are methods comprising receiving, by a vehicle, user information indicative of a user account associated with the vehicle, determining, based on the vehicle connecting to a service location, a condition associated with an ability to communicate with a billing network, determining, based on the user information and the condition, usage information associated with charging or discharging a battery via the service location, and sending the usage information to the billing network.

In an embodiment, are methods comprising receiving, by a vehicle, user information indicative of a user account associated with the vehicle, determining, based on the vehicle connecting to a service location, a condition associated with an ability to communicate with a billing network, determining, based not satisfying the condition, an availability of user information of an owner of the service location, and determining, based on the user information and based on the availability of the service owner user information, usage information associated with charging or discharging a battery via the service location.

In an embodiment, is an apparatus comprising an outlet interface, wherein the outlet interface is configured to engage an outlet associated with a service location, a communications interface, wherein the communications interface comprises one or more of a power line carrier interface, a cellular network interface, a WiFi network interface, a smart grid mesh network interface, or a short-range communication interface, and a computing device in communication with the outlet interface and the communications interface, wherein the computing device is configured to determine, based on the outlet interface engaging the outlet, a condition associated with an ability of the communications interface to communicate with a billing network, determine, based on the condition, usage information associated with charging or discharging a battery via the outlet, and send the usage information to the billing network.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of the present description serve to explain the principles of the methods and systems described herein. To easily identify the discussion of any particular element or act, the most significant digit or digits in a reference number may refer to the figure number in which that element is first introduced.

FIG. 1 shows an example system;

FIG. 2 shows an example communication network environment;

FIG. 3A shows an example system configuration;

FIG. 3B shows an example system configuration;

FIG. 3C shows an example system configuration;

FIGS. 4A-4B show a flowchart of an example method;

FIGS. 5A-5B show a flowchart of an example method;

FIGS. 6A-6B show a flowchart of an example method;

FIGS. 7A-7B show example device configurations;

FIG. 8 shows a flowchart of an example method;

FIG. 9 shows a flowchart of an example method;

FIG. 10 shows a flowchart of an example method;

FIG. 11 shows a flowchart of an example method;

FIG. 12 shows a flowchart of an example method;

FIG. 13 shows a flowchart of an example method;

FIG. 14 shows a flowchart of an example method

FIG. 15 shows a block diagram of a computing device for implementing the example methods.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes- from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium (e.g., non-transitory) having processor-executable instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These processor-executable instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These processor-executable instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the terms “user,” or “subject,” may indicate a person who uses an electronic device or a device (e.g., an artificial intelligence electronic device) that uses an electronic device.

Methods and systems are described for a smart adapter (e.g., mobile smart meter, smart charging adapter, etc.) used to connect an electric vehicle (EV) to an outlet (e.g., smart outlet, smart meter outlet, secure outlet, etc.) located at a service location (e.g., public residence, business, utility structure, etc.) associated with a service owner (e.g., residence or business owner or utility service provider). The smart adapter may be configured to engage in an outlet at the service location to charge or discharge a battery of the EV. The smart adapter and/or the smart outlet may be configured for bi-directional power flow wherein the vehicle may be configured to charge the battery in addition to causing the battery to discharge energy and provide power to a utility grid (e.g., vehicle to grid (V2G)). For example, V2G systems enable electric vehicles (e.g., battery electric vehicles, plug-in electric vehicles, hydrogen vehicles, etc.) to “sell” energy to the utility grid. The owner of the electric vehicle may be debited based on the amount of energy used to charge the battery or credited based on the amount of energy discharged by the battery of the electric vehicle. The smart adapter may be configured to receive user information indicative of a user account associated with the smart adapter. The smart adapter may be configured to engage with an outlet at a service location of a service owner in order to connect the EV to the outlet and charge or discharge the EV's battery.

Based on the smart adapter engaging the outlet, the smart adapter may attempt to communicate with a smart meter associated with the service owner of the outlet. In an example, the smart adapter may be configured to communicate with the smart meter via the outlet. For example, the outlet may comprise a power line carrier that may be coupled between the outlet and the smart meter, wherein the smart adapter may be configured to communicate with the smart meter via the power line carrier. In an example, the smart adapter may be configured to communicate with the smart meter via a wireless communication protocol (e.g., Zigbee, Wifi, etc.). If communication with the smart meter is available, the outlet may proceed with charging or discharging the battery. Once the charging/discharging process is completed, usage information associated with the energy used to charge the battery or the amount of energy discharged from the battery may by uploaded to a billing network. A user account associated with the EV owner may be debited based on the usage information and/or a user account associated with the service owner may be credited based the usage information.

If communication with the smart meter is unavailable, the smart adapter may attempt to communicate with a wireless network. The wireless network may comprise one or more of a smart grid mesh network, or a cellular/mobile network. In an example, the smart adapter may attempt to communicate with a wireless network via Wifi or Bluetooth. The smart adapter may be configured to receive user information associated with the service owner. If the user information is associated with a valid account, the user information may be sent to the service owner's outlet, wherein the outlet may commence charging or discharging the battery. If the user information is not associated with a valid account, the smart adapter may be configured to receive the user information from the EV owner. For example, the EV owner may manually enter the user information. The user information may be based on one or more of a QR code, utility account number, GPS coordinates, or address of the service owner. The user information may be sent to the service owner's outlet, wherein the outlet may commence charging or discharging the battery. Once the charging/discharging process is completed, usage information associated with the energy used to charge the battery or the amount of energy discharged from the battery may by uploaded to a billing network. A user account associated with the EV owner may be debited based on the usage information and/or a user account associated with the service owner may be credited based the usage information.

If communication with the smart meter is unavailable and the smart adapter cannot communicate with a wireless network, the smart adapter may obtain the user information associated with the service owner via a short-range communication network (e.g., Bluetooth or near field communication (NFC)). If the user information is associated with a valid account and the outlet has a WiFi connection, the outlet may act as a network gateway for the smart adapter. The smart adapter may send the user information to the outlet, wherein the outlet may begin charging or discharging the battery. Once the charging/discharging process is completed, usage information associated with the energy used to charge the battery or the amount of energy discharged from the battery may by uploaded to the billing network via the outlet. A user account associated with the EV owner may be debited based on the usage information and/or a user account associated with the service owner may be credited based the usage information.

If the user information is not associated with a valid account or the outlet does not have a WiFi connection, the smart adapter may receive the user information from the EV owner. For example, the EV owner may manually enter the user information. The user information may be based on one or more of a QR code, utility account number, GPS coordinates, or address of the service owner. The outlet may proceed with charging or discharging the battery. The usage information may be stored for sending to the billing network when a wireless network service becomes available. Once a wireless service is available and if the user information is associated with a valid user account, the user information may be uploaded to the billing network. A user account associated with the EV owner may be debited or credited based on the usage information and/or a user account associated with the service owner may be debited or credited based the usage information. If the user information is not associated with a valid user account, the smart adapter may attempt a reconciliation process via a utility service's customer service.

Methods and systems are described for a service owner's outlet (e.g., smart outlet, secure outlet, etc.) used to engage with an EV adapter (e.g., mobile smart meter, smart charging adapter, smart adapter, etc.). A device (e.g., laptop, tablet, mobile device, smartphone, etc.) associated with the service owner may receive user information associated with the service owner. The device may determine that a connection to a smart meter associated with the service owner is available or a connection to a wireless network is available. The wireless network may comprise one or more of a smart grid mesh network, a cellular/mobile network, or a WiFi network. If a connection to a wireless network is available, a NFC scan may be received from an EV owner's device. For example, the EV's owner's device may comprise one or more of a key fob associated with the EV, a mobile device, a smartphone, or a smart adapter. If the NFC scan is received and user information associated with the NFC scan is associated with a valid account, the outlet may proceed with charging or discharging the battery. If the NFC scan is not received or the user information associated with the NFC scan is not associated with a valid account, a billing system of the billing network may request use of the outlet and cause the outlet to commence charging or discharging the battery. Usage information associated with the amount of energy used to charge or discharge the battery may be uploaded to the billing network. A user account associated with the EV owner may be debited or credited based on the usage information and/or a user account associated with the service owner may be credited or debited based the usage information.

If a wireless connection is unavailable, or cannot be established, the device may receive user information associated with the EV owner via short-range communication (e.g., NFC or Bluetooth) and commence charging or discharging the battery. The usage information associated with the amount of energy used to charge the battery or the amount of energy discharged from the battery may be stored at the outlet and uploaded to the device once communication is established with the device. The usage information may be sent to the billing network once the wireless connection becomes available.

Each of the constitutional elements described in the present document may consist of one or more components, and names thereof may vary depending on a type of an electronic device. The electronic device according to various exemplary embodiments may include at least one of the constitutional elements described in the present document. Some of the constitutional elements may be omitted, or additional other constitutional elements may be further included. Further, some of the constitutional elements of the electronic device according to various exemplary embodiments may be combined and constructed as one entity, so as to equally perform functions of corresponding constitutional elements before combination.

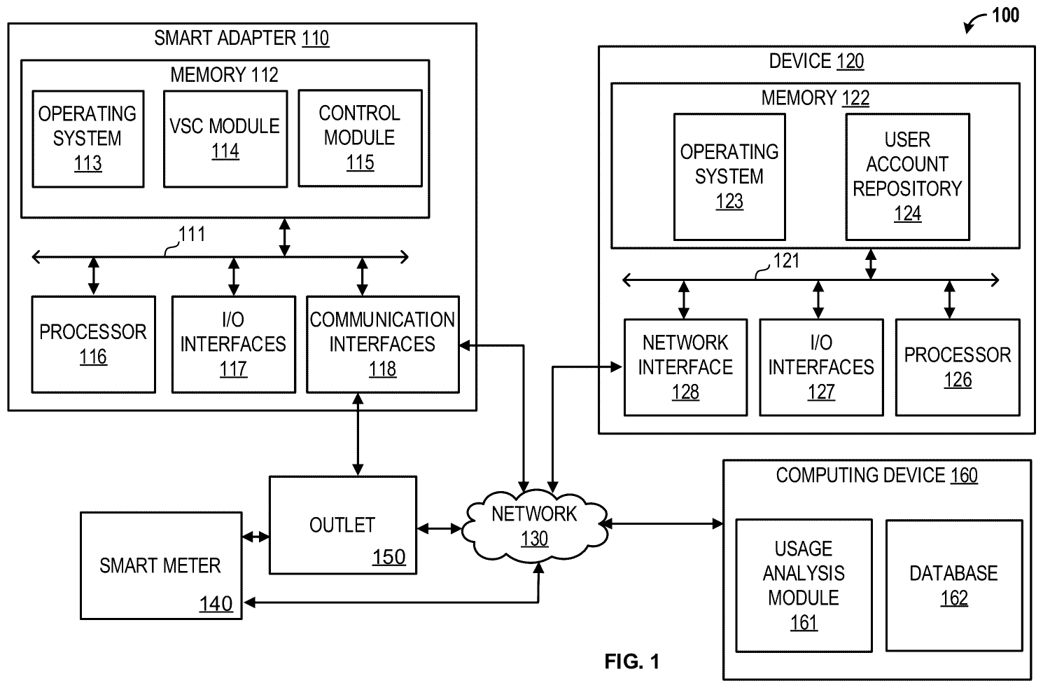

FIG. 1 shows an example system 100 for using a smart adapter 110 (e.g., mobile smart meter, smart charging adapter, etc.) and/or an outlet 150 (e.g., smart outlet, smart meter outlet, secure outlet, etc.). In one example, the smart adapter 110 may be configured to determine an amount of energy used to charge a battery of an electric vehicle (EV) via an outlet at a service location of a service owner and bill the owner of the EV an amount associated with the amount of energy used to charge the battery. In another example, the smart adapter 110 may be configured for bi-directional power flow enabling the battery to be discharged and provide power to a utility grid. An amount of energy discharged by the battery may be determined and the owner of the EV may be credited an amount associated with the amount of energy discharged. The system 100 may comprise a smart adapter 110, a device 120, a smart meter 140, an outlet 150 (e.g., smart meter outlet, secure outlet, smart outlet, etc.), and a computing device 160. In an example, the devices may omit at least one of the aforementioned constitutional elements or may additionally include other constitutional elements.

The smart adapter 110 may be configured to connect to an EV and couple the EV to an outlet (e.g., outlet 150) of a service owner to charge or discharge the battery of the EV. The smart adapter 110 may include a bus 111, memory 112, one or more processors 116, one or more input/output interfaces 117, and one or more communication interfaces 118. In an example, the smart adapter 110 may omit at least one of the aforementioned elements or may additionally include other elements.

The bus 111 may include a circuit for connecting the memory 112, the one or more processors 116, the one or more input/output interfaces 117, and the one or more communication interfaces 118 to each other and for delivering communication (e.g., a control message and/or data) between the bus 110, the memory 112, the one or more processors 116, the one or more input/output interfaces 117, and the one or more communication interfaces 118. The bus 110 may comprise a plurality of buses or other wired or wireless connections. The bus 111 may comprise additional elements, such as controllers, buffers (caches), drivers, repeaters, and receivers, to enable communications. Further, the local interface may include address, control, and/or data connections to enable appropriate communications among the aforementioned components.

The memory 112 may include one or a combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 112 may incorporate electronic, magnetic, optical, and/or other types of storage media. The memory 112 may have a distributed architecture, where various components are situated remote from one another, but may be accessed by the one or more processors 116.

The memory 112 may include one or more software programs, each of which comprises an ordered listing of executable instructions for implementing logical functions. The software in the memory 112 may include an operating system 113, a vehicle systems and components (VSC) module 114, and a control module 115. The operating system 113 may control the execution of other computer programs and provides scheduling, input-output control, file and data management, memory management, and communication control, and related services.

The VSC module 114 may communicate with systems and components of the EV, such as the electric motor and an energy storage module (e.g., battery). The VSC module 114 may determine a state (e.g., an operational state, a communication state, etc.), an operation, a mode, a configuration, and/or the like associated with the systems and components of the EV, such as an electric motor and the energy storage module (e.g., battery) of the EV. The VSC module 114 may communicate and/or exchange data/information with the control module 115. The control module 115 may communicate and/or exchange information with one or more of an outlet 150, a smart meter 150, and/or a computing device 160 (e.g., billing system, billing network, etc.). For example, the control module 115 may communicate and/or exchange information with the EV, such as usage information (e.g., charging information and/or discharging information). The usage information may comprise information indicative of an amount of energy used to charge a battery of the EV and/or an amount of energy discharged by the battery of the EV if the vehicle is being used to provide power back into the power grid (e.g., vehicle to grid (V2G)). The control module 115 may determine and/or store usage information, for example, whenever the EV connects to and/or receives a charge (e.g., electricity, power, energy, etc.) from, or provides energy to, the outlet 150. The control module 115 may determine and/or store usage information to facilitate time-varying electricity rates and/or pricing, such as Time of Use (TOU), Critical Peak Pricing (CPP), Real-Time Pricing (RTP), and/or the like for residences and/or service locations associated with the outlet 150 and/or EV. In an example, usage information may be used by a utility service provider, to determine the cost for electrical usage (consumption) dependent upon the time of use to incentivize off-peak EV charging behavior. A user account associated with the EV owner may be debited based on the usage information and/or a user account associated with the service owner may be charged based on the usage information. In an example, a utility service provider may output an override signal to cause the EV to stop discharging the battery.

Usage information may include, for example, data/information related to the systems and components of the EV such as an electric motor of the EV, as well as data/information related to the recharging, or the discharging, of the energy storage module (e.g., battery) of the EV and the outlet 150. Usage information may include, for example, ignition status (e.g., ON/OFF), location information (e.g., GPS coordinates, an address associated with an EV and/or service location, etc.), temporal charging/discharging information (e.g., a charge/discharge start time/date and/or a charge/discharge end time/date), a time of use (TOU) rate, a charging/discharging energy source information (e.g., service location details, communication protocols associated with a service location, data format and/or encryption/decryption information associated with a service location, etc.), a charge/discharge amount, a current state-of-charge (SOC), a SOC at the charge/discharge start time, a SOC at the charge/discharge end time, a utility area/region, a battery type, a charger type, charger timer usage, an ignition ON time, an ignition OFF time, and/or the like. The usage information may be sent to a computing device 160. The computing device 160 may store the usage information in a database 162 to be used for adjusting the bill for the service owner and the EV owner and/or for crediting the EV owner based on an amount of an energy discharged from the energy storage module of the EV to the utility grid.

The one or more processors 116 may include one or more of a Central Processing Unit (CPU), an Application Processor (AP), or a Communication Processor (CP). The one or more processors 116 may control, for example, at least one of the bus 111, the memory 112, the VSC module 114, the control module 115, the one or more input/output interfaces 117, and/or the one or more communication interfaces 118 of the smart adapter 110 and/or may execute an arithmetic operation or data processing for communication. The processing (or controlling) operation of the one or more processors 116 according to various embodiments is described in detail with reference to the following drawings.

The one or more processors 116 may facilitate EV charging/discharging analysis, for example, to determine EV electricity consumption, EV electricity discharge, and related electricity consumption/discharge rates. When the smart adapter 110 is in operation, the one or more processors 116 may execute software stored within the memory 112, to communicate data to and from the memory 112, and to generally control operations of the smart adapter 110 pursuant to the software. For example, the one or more processors 116 may be configured to determine the user information received by the smart adapter 110. The user information may comprise information indicative of a user account associated with an owner of the smart adapter 110 or an owner of the EV. Based on the smart adapter 110 engaging the outlet 150, the one or more processors 116 may be configured to cause the smart adapter 110 to attempt to communicate, via the one or more communication interfaces 118, with a smart meter 140 associated with a service owner of the outlet 150. For example, the smart adapter 110 may communicate with the smart meter 140 via a power wiring (e.g., power line carrier) that may be coupled between the outlet 150 and the smart meter 140. If communication with the smart meter 140 is available, the outlet 150 may proceed with charging or discharging the battery. For example, the outlet 150 (e.g., smart outlet, smart meter outlet, secure outlet, etc.) may close an internal switch in order to commence the charging process, or commence the discharging process. In another example, the smart adapter 110 itself may initiate the charge/discharge of the battery, such as when the smart adapter 110 plugs into an ordinary outlet that does not comprise a smart outlet. In an example, an override signal may be received that causes the smart adapter 110 to discontinue discharging the battery and providing power to a utility grid. The override signal may be received from a utility provider associated with the utility grid. In an example, the charging or discharging of the battery may be initiated based on input received from the owner of the EV. For example, the owner of the EV may wish to only charge or discharge the battery at certain times of the day to efficiently manage the cost of charging the battery or manage the benefit associated with discharging the battery. For example, a utility provider may provide different energy costs, or benefits, during certain times of the day.

Once the charging/discharging process is completed, the one or more processors 116 may cause the usage information to be sent to the computing device 160 (e.g., billing system, billing network) via the smart meter 140. As an example, a user account associated with the EV owner may be debited/credited based on the usage information and/or a user account associated with the service owner may be credited based on the usage information. In an example, in situations where the user account associated with the service owner is provided a credit based on an amount of energy provided to a utility grid via the service owner's outlet 150, the user account associated with the service owner may be debited based on the usage information.

If communication with the smart meter 140 is unavailable, the one or more processors 116 may be configured to cause the smart adapter 110 to attempt to communicate with a wireless network 130. For example, the wireless network 130 may comprise one or more of a smart grid mesh network or a cellular/mobile network. The smart adapter 110 may receive user information associated with a service owner of the outlet 150. If the service owner user information is associated with a valid account, the one or more processors 116 may be configured to cause the service owner user information to be sent to the outlet 150, wherein the smart adapter 110 or the outlet 150 may commence the charging/discharging process. If the service owner user information is not associated with a valid user account, the smart adapter 110 may be configured to receive the service owner user information from the EV owner. For example, the EV owner may manually enter the service owner user information. The service owner user information may be based on one or more of a QR code, utility account number, GPS coordinates, or address of the service owner. The one or more processors 116 may cause the service owner user information to be sent to the outlet 150, wherein the outlet 150 may commence the charging process. Once the charging process is completed, the one or more processors 116 may cause usage information associated with the energy used to charge/discharge the battery to be uploaded, or sent, to the computing device 160 (e.g., billing system, billing network).

If communication with the smart meter 140 is unavailable and the smart adapter 110 cannot communicate with a wireless network 130, the one or more processors 116 may cause the smart adapter 110 to obtain the service owner user information via a short-range communication network (e.g., Bluetooth, NFC). For example, the smart adapter 110 may receive the service owner user information from the outlet 150 via the short-range communication network. If the service owner user information is associated with a valid account and the outlet 150 has a WiFi connection, the outlet 150 may act as a network gateway for connecting the smart adapter 110 to the computing device 160 (e.g., billing system, billing network). The one or more processors 116 may cause the smart adapter 110 to send the service owner user information to the outlet 150, wherein the outlet 150 may commence the charging/discharging process. Once the charging process is completed, the one or more processors 116 may cause usage information associated with the energy used to charge/discharge the battery to be uploaded, or sent, to the computing device 160 (e.g., billing system, billing network).

If the service owner user information is not associated with a valid user account or the outlet 150 does not have a WiFi connection, the smart adapter 110 may be configured to receive the user information from the EV owner. For example, the EV owner may manually enter the user information. The service owner user information may be based on one or more of a QR code, utility account number, GPS coordinates, or address of the service owner. The outlet 150 or the smart adapter 110 may proceed with charging/discharging the battery. The one or more processors 116 may cause the usage information to be stored, in the memory 112, for example, for sending to the computing device 160 (e.g., billing system, billing network) when a wireless network service becomes available. Once a wireless network service becomes available and if the service owner user information is associated with a valid user account, the one or more processors 116 may cause the usage information to be uploaded to the computing device 160 (e.g., billing system, billing network).

The smart adapter 110 may include one or more input/output (I/O) interfaces 117. The one or more I/O interfaces 117 may be used to receive user input from, and/or for providing system output to, one or more devices or components. Input may be provided via, for example, a keyboard, a touchscreen, a voice-activated control, and/or the like. Output may be provided via one or more audio units (e.g., speakers, etc.) and/or a display (e.g., a head unit, a display stack, a heads-up display). The one or more I/O interfaces 117 may include, for example, a serial port, a parallel port, a Small Computer System Interface (SCSI), an infrared (IR) interface, a radio frequency (RF) interface, and/or a universal serial bus (USB) interface.

The one or more communication interfaces 118 may be used to transmit and receive data/information from the smart adapter 110, the outlet 150, and/or the computing device 160. The one or more communication interfaces 118 may include, for example, a 10 BaseT Ethernet Adaptor, a 10 BaseT Ethernet Adaptor, a LAN PHY Ethernet Adaptor, a Token Ring Adaptor, a wireless network adapter (e.g., WiFi, cellular, satellite), or any other suitable network interface device. The one or more communication interfaces 118 may include address, control, and/or data connections to enable appropriate communications on the network 130 (e.g., a smart grid mesh network, a wireless network, a cellular network, a packet-switched network, etc.). The one or more communication interfaces 118 may include one or more charging links to connect the smart adapter 110, and thus, the EV, to the outlet 150 in order to charge the EV's battery. The one or more charging links may support single-phase vehicle couplers, single-phase and three-phase vehicle couplers, single-phase and three-phase vehicle couplers equipped with safety shutters, fast charge couplers, and/or the like.

The device 120 may comprise one or more of a mobile device, a smartphone, a laptop device, a desktop, or a tablet. The device 120 may include a bus 121, memory 122, one or more processors 126, one or more input/output (I/O) interfaces 127, and a network interface 128. In an example, the device 120 may omit at least one of the aforementioned elements or may additionally include other elements.

The bus 121 may include a circuit for connecting the memory 122, the one or more processors 126, the one or more input/output interfaces 127, and the network interface 128 to each other and for delivering communication (e.g., a control message and/or data) between the bus 121, the memory 122, the one or more processors 126, the one or more input/output interfaces 127, and the network interface 128. The bus 121 may comprise a plurality of buses or other wired or wireless connections. The bus 121 may comprise additional elements, such as controllers, buffers (caches), drivers, repeaters, and receivers, to enable communications. Further, the local interface may include address, control, and/or data connections to enable appropriate communications among the aforementioned components.

The memory 121 may include one or a combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 121 may incorporate electronic, magnetic, optical, and/or other types of storage media. The memory 121 may have a distributed architecture, where various components are situated remote from one another, but may be accessed by the one or more processors 126.

The memory 121 may include one or more software programs, each of which comprises an ordered listing of executable instructions for implementing logical functions. For example, the software in the memory 121 may include an operating system 123 and a user account repository 124. The operating system 123 may control the execution of other computer programs and provides scheduling, input-output control, file and data management, memory management, and communication control, and related services.

The user account repository 124 may store user data/information associated with the service owner, such as data/information associated with utility services or a residence/service location associated with the service owner. The service owner user information may be stored and/or associated with a user account associated with the service owner. For example, the user account may be based on billing information associated with the service owner's utility services. The user account may include utility (e.g., electricity, etc.) consumption/usage data/information and any related cost, payment, and/or bill information.

The one or more processors 126 may include one or more of a Central Processing Unit (CPU), an Application Processor (AP), or a Communication Processor (CP). The one or more processors 126 may control, for example, at least one of the bus 121, the memory 122, the one or more input/output interfaces 127, and/or the network interface 128 of the device 120 and/or may execute an arithmetic operation or data processing for communication. The processing (or controlling) operation of the one or more processors 126 according to various embodiments is described in detail with reference to the following drawings.

The one or more processors 126 may facilitate EV charging/discharging analysis, for example, to determine EV electricity consumption and related electricity consumption rates and/or determine EV electricity discharge and related electricity discharge rates. When the smart adapter 110 is in operation, the one or more processors 126 may execute software stored within the memory 122, to communicate data to and from the memory 122, and to generally control operations of the device 120 pursuant to the software. For example, the device 120 may be configured to receive user information associated with the service owner. Based on receiving the service owner user information, the one or more processors 126 may cause the device 120 to determine whether a connection to the smart meter 140 is available or whether a connection to a wireless network 130 is available. The wireless network may comprise one or more of a smart grid mesh network, a cellular/mobile network, or a WiFi network. If the connection to the smart meter 140 is available or the connection to the wireless network is available, the one or more processors 126 may cause the device 120 to determine whether a NFC scan is received from a device associated with the EV owner. The NFC scan may comprise information indicative of user information associated with the EV owner. The device associated with the EV owner may comprise one or more of a key fob, mobile device, smartphone, or the smart adapter 110. If the NFC scan is received and the EV owner user information is associated with a valid account, the one or more processors 126 may cause the device 120 to instruct the outlet 150 to close an internal switch and commence charging or discharging the battery of the EV. In one example, the smart adapter 110 itself may commence charging or discharging the battery of the EV. If the NFC scan is not received or the EV owner user information is not associated with a valid account, the one or more processors 126 may cause the device 120 to instruct the computing device 160 (e.g., billing system, billing network) to send a request/command to the outlet 150 to commence the charging/discharging process. Once the charging/discharging process is complete, the usage information associated with the energy consumed to charge the battery, or the energy discharged from the battery, may be sent to the computing device 160 (e.g., billing system, billing network). As an example, a user account associated with the EV owner may be debited based on the usage information and/or a user account associated with the service owner may be credited based the usage information. In an example, in situations where the user account associated with the service owner is provided a credit based on an amount of energy provided to a utility grid via the service owner's outlet 150, the user account associated with the service owner may be debited based on the usage information.

If the connection to the smart meter is unavailable and the connection to the wireless network is unavailable, the device 120 may be configured to receive the EV owner user information via a short-range communication network (e.g., Bluetooth, NFC). The one or more processors 126 may cause the device 120 to instruct the outlet 150 to close an internal switch and commence charging or discharging the battery of the EV. Once the charging/discharging process is complete, the usage information associated with the amount of energy consumed to charge the battery may and/or an amount of energy discharged from the battery of the EV be stored, on the outlet 150, for example. The one or more processors 126 may cause the device 120 to receive the usage information from the outlet 150 when the connection between the device 120 and the outlet 150 becomes available. The one or more processors 126 may cause the device 120 to send the usage information to the computing device 160 once one or more wireless network services become available.

The device 120 may include one or more I/O interfaces 127. The one or more I/O interfaces 127 may be used to receive user input from, and/or for providing system output to, one or more devices or components. Input may be provided via, for example, a keyboard, a touchscreen, a voice-activated control, and/or the like. Output may be provided via one or more audio units (e.g., speakers, etc.) and/or a display. The one or more I/O interfaces 127 may include, for example, a serial port, a parallel port, a Small Computer System Interface (SCSI), an infrared (IR) interface, a radio frequency (RF) interface, and/or a universal serial bus (USB) interface.

A network interface 128 may be used to transmit and receive data/information from the smart adapter 110 and/or the computing device 160. The network interface 128 may include, for example, a 10 BaseT Ethernet Adaptor, a 10 BaseT Ethernet Adaptor, a LAN PHY Ethernet Adaptor, a Token Ring Adaptor, a wireless network adapter (e.g., WiFi, cellular, satellite), or any other suitable network interface device. The network interface 128 may include address, control, and/or data connections to enable appropriate communications on the network 130.

Network 130 may comprise a wireless communication network or a wired communication network. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In addition, the wireless communication network may include a smart grid mesh network. Further, the wireless communication may include, for example, a near-distance communication. The near-distance communications may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 130 may include, for example, at least one of a telecommunications network, a computer network (e.g., LAN, WAN, WiFi, etc.), the Internet, and a telephone network.

The computing device 160 may comprise one or more devices associated with a billing system/network. For example, the computing device 160 may comprise one or more servers. The computing device may comprise a usage analysis module 161 and a database 162. The computing device 160 may be configured to receive the usage information from the smart adapter 110, the device 120, the smart meter 140, the outlet 150, or any combination thereof. For example, the computing device 120, via the usage analysis module 161, may analyze usage information, user information indicative of a user account associated with the service owner, and/or user information indicative of a user account associated with the EV owner to store usage information and/or data/information determined from and/or associated with usage information. Usage information received from the EV may include identification information, such as user information associated with the EV owner or the owner of the smart adapter 110, user information associated with the service owner of the outlet, EV identification information, location information, and/or the like. The user information associated with the service owner and the user information associated with the EV owner may be stored in a database 162 of the computing device 160.

The usage analysis module 161 may identify, based on the usage information, energy consumption or discharge values (e.g., measured in kilowatt-hours, etc.) and/or time information (e.g., charging/discharging start/end times/periods, etc.) associated with the smart adapter 110 charging or discharging the battery of the EV. The usage analysis module 161 may use the usage information to either debit a user account associated with the EV and/or credit a user account associated with the service owner. In one example, the usage analysis module 161 may determine a cost amount associated with the energy consumed to charge the battery of the EV and debit a user account associated with the EV and/or credit an account associated with the service owner. In another example, in situations where the user account associated with the service owner is provided a credit based on an amount of energy provided to a utility grid, the usage analysis module 161 may use the usage information to debit the user account associated with the service owner based on an amount of energy received by the EV.

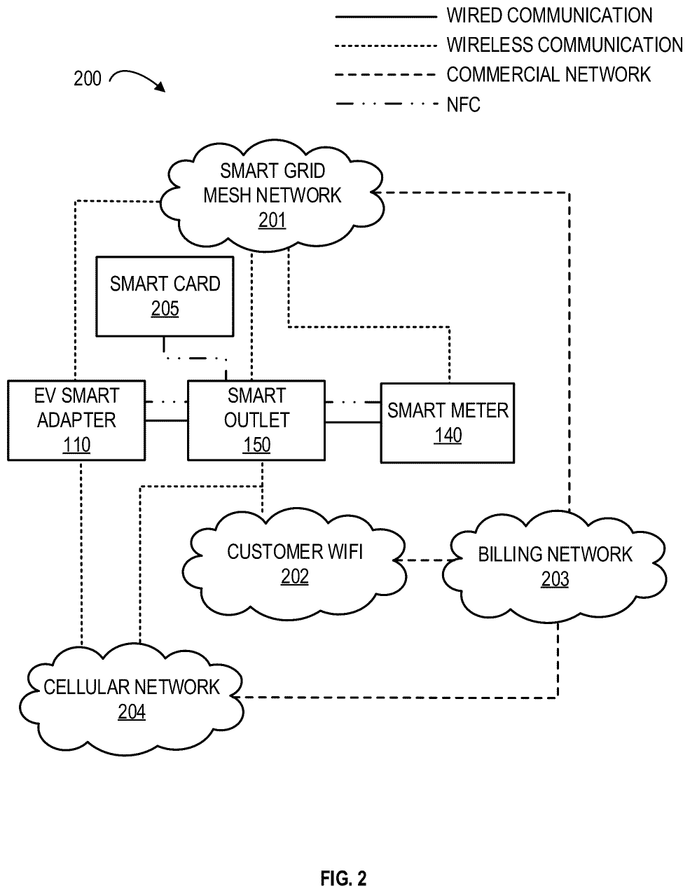

FIG. 2 shows an example communication network environment 200. The communication network 200 may include an EV smart adapter 110, a smart meter 140, a smart outlet 150, a smart grid mesh network 201, a customer WiFi network 202, a utility billing network 203, a cellular network 204, and a smart card 205. The smart adapter 110 may be configured to engage a secure outlet 150 at a service location associated with a service owner. For example, the service location may comprise a public or private residence owned by the service owner or a utility structure. In an example, either the smart adapter 110 or the secure outlet 150 may be used separately and not at the same time. For example, the smart adapter 110 may be configured to engage a residential outlet (e.g., non-smart, outlet) or the smart outlet 150 may be configured to engage an EV adapter (e.g., non-smart adapter). The smart adapter 110 may be configured to communicate with a smart meter 140 of a service owner. In an example, the smart adapter 110 may communicate with the smart meter 140 via wireless communication such as Zigbee, WiFi communication 202, or the smart grid mesh network 201. In an example, the smart adapter 110 may be configured to communicate with the smart meter 140 via a short-range communication protocol (e.g., NFC, Bluetooth, etc.) via the secure outlet 150. In an example, the smart adapter 110 may communicate with the smart meter 140 via a power line carrier of the smart outlet 150. For example, the power line carrier of the smart outlet 150 may be configured to couple the smart outlet 150 with the smart meter 140, wherein the smart adapter 110 may communicate with the smart meter 140 via the power line carrier of the smart outlet 150. As an example, the power line carrier may comprise the 120 VAC or 240 VAC power wires coupled between the smart outlet 150 and the smart meter 140. If the smart adapter 110 is able to communicate with the smart meter 140 via the power line carrier of the smart outlet 150, charging or discharging of the EV's battery may be initiated. Once the charging/discharging process is completed, the smart adapter 110 may be configured to send usage information associated with the energy used to charge or discharge the battery to the billing network 203 via the smart meter 140 via the smart grid mesh network 201, wherein the smart grid mesh network 201 may communicate with the billing network 203 via a commercial network, such as the Internet, for example. In an example, the smart adapter 110 may be configured to send the usage information associated with the energy used to charge or discharge the battery to the billing network 203 via the smart outlet 150, wherein the smart outlet 150 may communicate with the billing network 203 via customer WiFi 202.

As an example, if communication with the smart meter 140 is unavailable, the smart adapter 110 may communicate with the billing network 203 via a wireless network. The wireless network may comprise a WiFi network 202 or a cellular/mobile network 204. For example, the smart adapter 110 may communicate with the billing network 203 via the smart outlet 150 via the WiFi network 202. The smart outlet 150 may commence the charging/discharging process of the battery of the EV. Once the charging/discharging process has completed, the smart adapter 110 may send the usage information to the billing network 203 via the wireless network.

In an example, the smart outlet 150 may be configured to communicate with a smart card 205. For example, the smart outlet 150 may be configured to communicate with the smart card 205 via a short-range communication protocol (e.g., Bluetooth, NFC, etc.). For example, the smart card 205 may comprise one or more of a ChargePoint Card or a utility-issued card. The smart card 205 may be configured to transfer utility billing information associated with the service owner to the smart outlet 150.

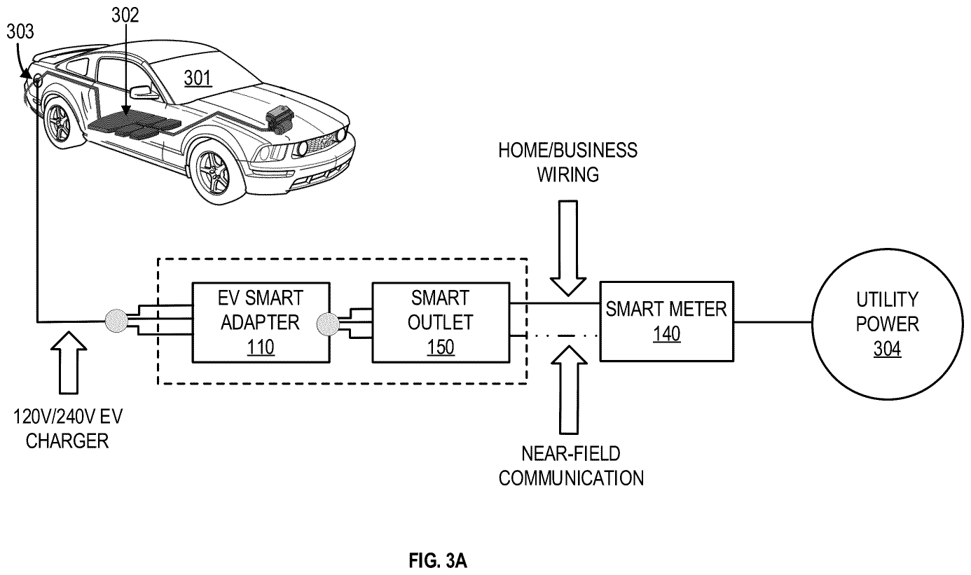

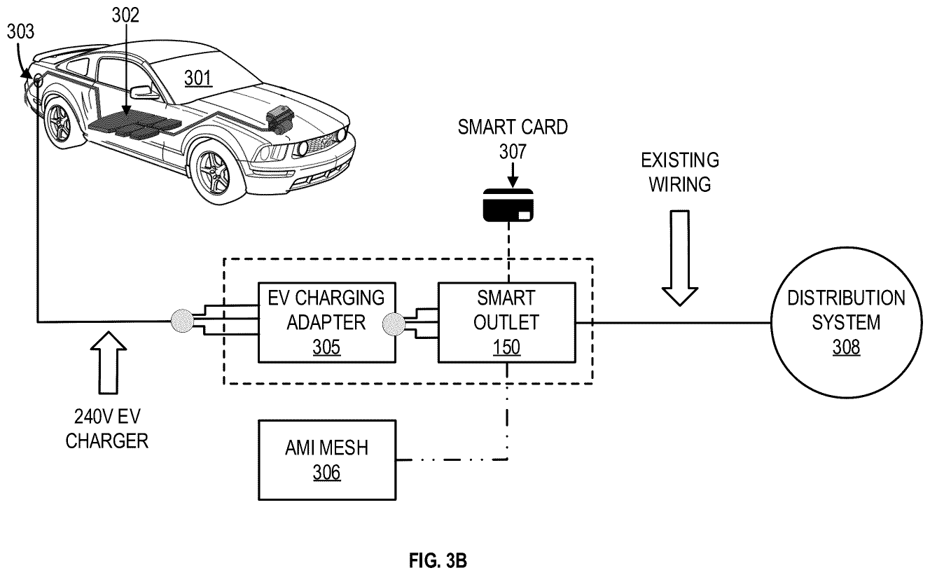

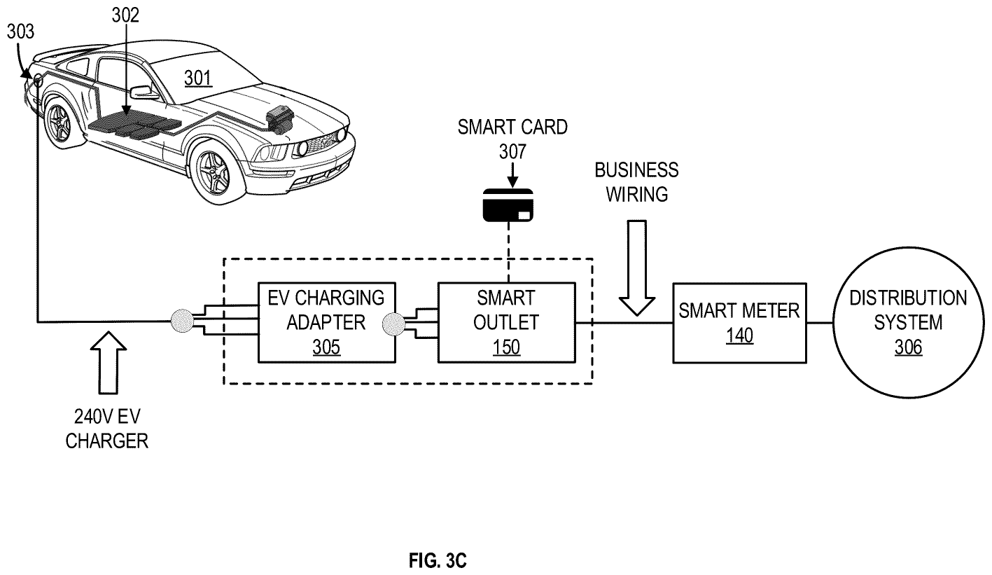

FIGS. 3A-3C shows example system configurations. FIG. 3A shows an example wherein an electric vehicle (EV) smart adapter 110 may be used to engage a smart outlet 150 at a private/public home or business that uses a smart meter 140. As shown in FIG. 3A, an EV 301 may include an energy storing module 302 (e.g., battery) and a smart outlet 150 for engaging a smart adapter 110, wherein the smart adapter 110 is configured to couple the EV 301 to a charging source such as a smart outlet 150. The energy storing module 302 may comprise one or more of a lithium-ion battery, a nickel-metal hydride battery, a lead-acid battery, an ultracapacitor, and/or any other type of energy storage device/module/component. The smart adapter 110 may be configured to engage with a 120 V or a 240 V EV charger. In an example, smart outlet 150 may be coupled with the smart meter 140 via home/business wiring such as a power line carrier of the smart outlet 150. In an example, the smart outlet 150 may be configured to communicate with the smart meter 140 via a short-range communication protocol (e.g., NFC, Bluetooth, etc.). The smart meter 150 may provide power to the EV 301 via a utility power source 304 of the service owner.

FIG. 3B shows an example wherein an EV adapter 305 (e.g., a 240V charger, non-smart mobile meter, or non-smart EV adapter) is used to engage a smart outlet 150 of a public structure in order to charge the energy storing module 302 (e.g., battery) of an EV 301. For example, a utility provider may install a smart outlet 150 (e.g., smart meter outlet) at existing public infrastructure such as a street light pole or utility pole. As shown in FIG. 3B, the smart outlet 150 may be configured to communicate with a smart card 307 and with an advanced metering infrastructure (AMI) mesh network 306. For example, the AMI mesh network 306 may comprise a two-way communication system to collect detailed metering information through a utility provider's service industry. The smart card 307 may comprise one or more of a ChargePoint Card or a utility-issued card. The smart card 307 may be configured to transfer utility billing information associated with the service owner to the smart outlet 150. Thus, the smart outlet 150 may provide usage information associated with the amount of energy used to charge the battery 302 or amount of energy discharged from the battery 302 to the billing system via the AMI mesh network 306. For example, the smart outlet 150 may provide energy to, or receive energy from, the utility provider via the distribution system 308.

FIG. 3C shows an example wherein an EV adapter 305 (e.g., a 240V charger, non-smart mobile meter, or non-smart EV adapter) is used to engage a smart outlet 150 of a business. For example, the smart outlet 150 (e.g., smart meter outlet) may be a stationary outlet associated with a business, or business owner. For example, the smart outlet 150 may be used at office builders, hotels, malls, grocery stores, parking lots, and the like. The smart outlet 150 and/or the smart meter 140 may communicate with the billing system via the public Internet (e.g., cellular, WiFi, AMI mesh network, power-line carrier, etc.). For example, the smart outlet 150 and/or the smart meter 140 may provide usage information associated with the amount of energy used to charge the battery 302 or the amount of energy discharged from the battery 302 to the billing system via a network (e.g., the public Internet). For example, the smart meter 140 may provide energy to, or receive energy from, the utility provider via the distribution system 308. As shown in FIG. 3C, the secure outlet 150 may be configured to communicate with a smart card 307 (e.g., a ChargePoint Card or a utility-issued card) configured to transfer utility billing information associated with the service owner to the secure outlet 150.

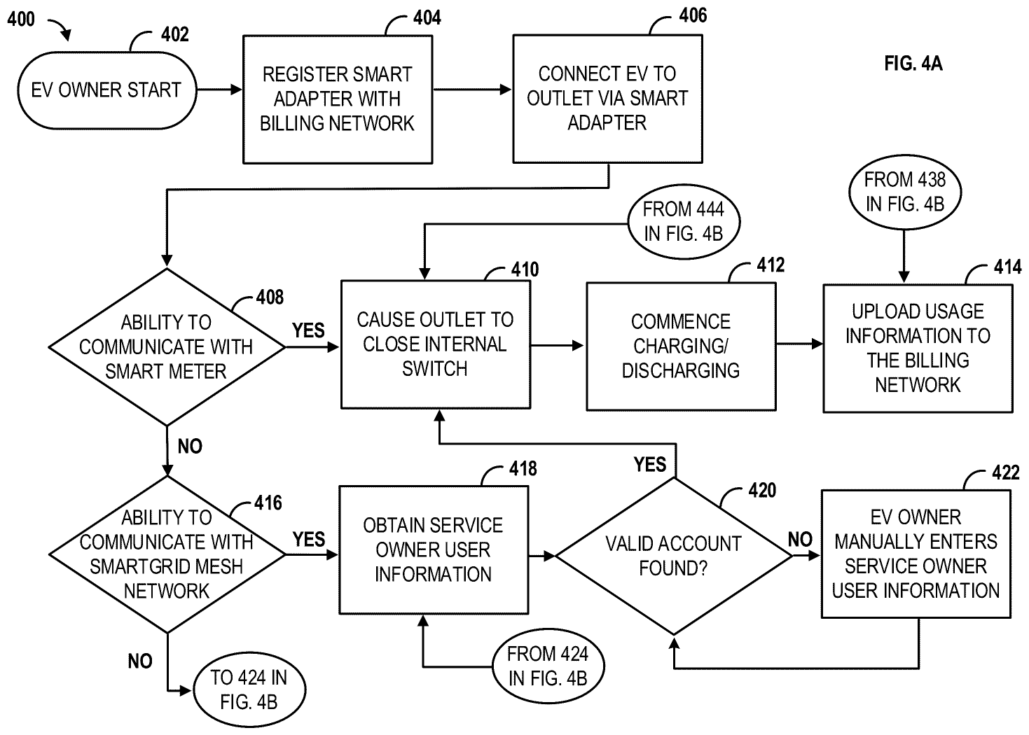

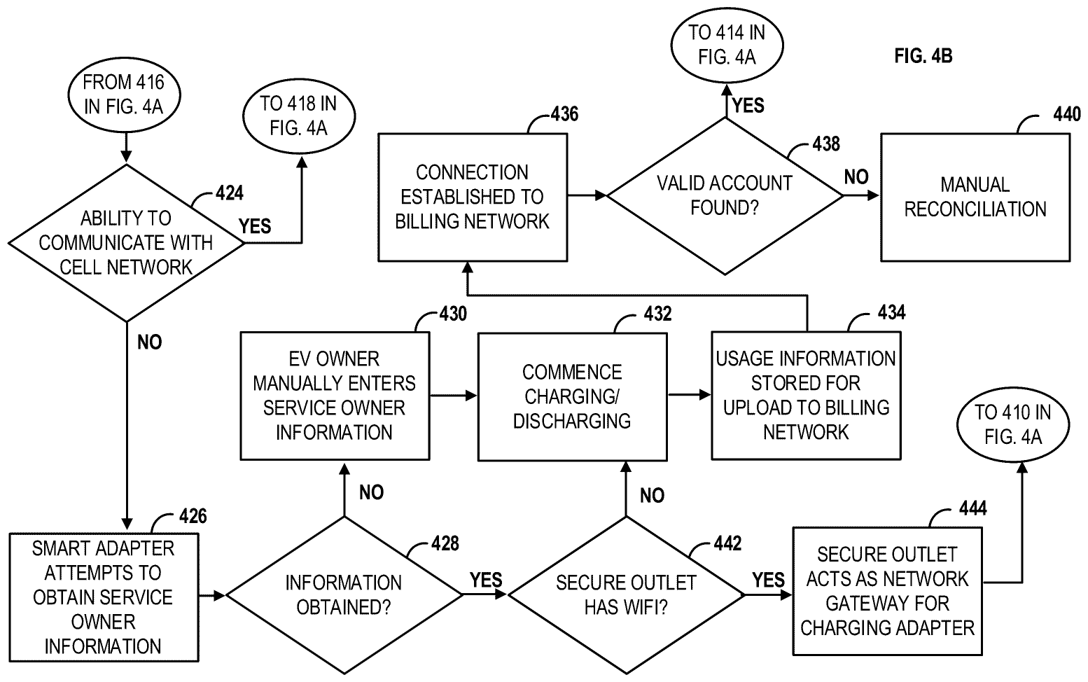

FIGS. 4A-4B show a flowchart of an example method 400 for charging or discharging a battery of an EV. The method 400 may be implemented in whole or in part by the smart adapter 110, and/or any other suitable computing device. The process may start at 402 by the EV owner. At 404, the EV owner may register the smart adapter 110 with the billing network. For example, the EV owner may provide user information associated with the EV owner such as account information or an identifier of the EV owner associated with the smart adapter 110. At 406, the EV may be connected to the smart outlet 150 via the smart adapter 110. At 408, a determination is made as to whether the smart adapter 110 can communicate with a smart meter 140 associated with the smart outlet 150. For example, a power line carrier coupling the smart outlet 150 with the smart meter 140 may be used by the smart adapter 110 to communicate with the smart meter 140. If the smart adapter 110 can communicate with the smart meter 140, the YES branch may be followed to 410. At 410, the smart outlet 150 may close an internal switch. At 412, the smart outlet 150 may commence charging a battery of the EV. In an example, at 412, the smart outlet 150 may commence discharging the battery of the EV providing the energy discharged from the battery to a utility grid. Once the charging/discharging process is complete, usage information associated with the amount of energy used to charge the battery or the amount of energy discharged from the battery may be uploaded to the billing network at 414.

Returning to 408, if the smart adapter 110 cannot communicate with the smart meter 140, the NO branch may be followed to 416 or to 424. At 416, it is determined whether the smart adapter 110 can communicate with a smart grid mesh network. At 424, it is determined whether the smart adapter 110 can communicate with a cellular network. If the smart adapter 110 can communicate with the smart grid mesh network or the smart adapter 110 can communicate with the cellular network, the YES branch may be followed to 418. At 418, user information associated with the service owner may be received. At 420, it may be determined whether the service owner user information is associated with a valid user account. For example, the service owner user information may be sent to the billing network, wherein the billing network may provide a response indicating whether the user information is a valid user account. If the service owner user information is associated with a valid account, the YES branch may be followed to 410. If the service owner user information is not associated with a valid account, the NO branch may be followed to 422. At 422, the EV owner may manually enter the service owner user information using a QR code, a utility account number, GPS coordinates, or an address of the service owner and the branch may proceed to 410. In an example, the service owner user information (e.g., QR code, utility account number, GPS coordinates, or service owner address) may be sent to the billing network, wherein the billing network may provide a response indicating whether the user information corresponds to a valid user account. At 410, the smart outlet 150 may close an internal switch. At 412, the smart outlet 150 may commence charging or discharging a battery of the EV. Once the charging/discharging process is complete, usage information associated with the amount of energy used to charge the battery or the amount of energy discharged from the battery may be uploaded to the billing network at 414.

Returning to 416/424, if the smart adapter 110 cannot communicate with the smart grid mesh network at 416, or the smart adapter 110 cannot communicate with the cellular network at 424, the NO branch may be followed to 426. At 426, the smart adapter may attempt to obtain user information associated with the service owner from the smart outlet 150 via short-range communication (e.g., Bluetooth, NFC, etc.). At 428, it is determined whether the service owner user information was obtained. If the service owner user information was not obtained, the NO branch may be followed to 430. At 430, the EV owner may manually enter the service owner user information using a QR code, a utility account number, GPS coordinates, or an address of the service owner. The branch may proceed to 432, wherein the smart outlet 150 may close an internal switch and commence charging or discharging the battery. At 434, the usage information associated with the amount of energy consumed to charge the battery or the amount of energy discharged from the battery may be stored for upload to the billing network when a wireless network service becomes available. At 436, a wireless network service may become available. At 438, it is determined whether the usage information is associated with a valid account. If the usage information is associated with a valid account, the YES branch may be followed to 414, wherein the usage information may be uploaded to the billing network. If the usage information is not associated with a valid user account, the NO branch may be followed to 440. At 440, a manual reconciliation process may be performed via a utility customer service.

Returning to 428, if the service owner user information was obtained, the YES branch may be followed to 442. At 442, it is determined if the smart outlet 150 has a WiFi connection. If it is determined that the smart outlet 150 does not have a WiFi connection, the NO branch may be followed to 432. Returning to 442, if it is determined that the smart outlet 150 has a WiFi connection, the YES branch may be followed to 444. At 444, the smart outlet 150 may be configured to act as a network gateway for the smart adapter 110 and the branch may proceed to 410. At 410, the smart outlet 150 may close an internal switch. At 412, the smart outlet 150 may commence charging or discharging a battery of the EV. Once the charging/discharging process is complete, usage information associated with the amount of energy used to charge the battery, or the amount of energy discharged from the battery, may be uploaded to the billing network at 414. The usage information may be used to debit a user account associated with the EV and/or debit a user account associated with the service owner. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

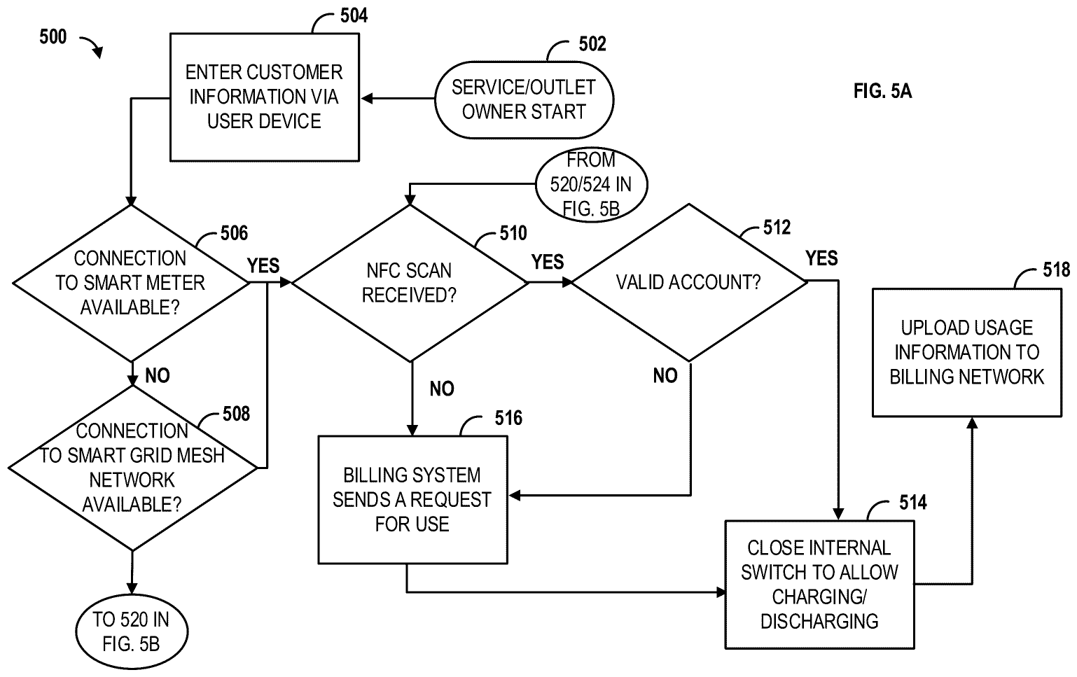

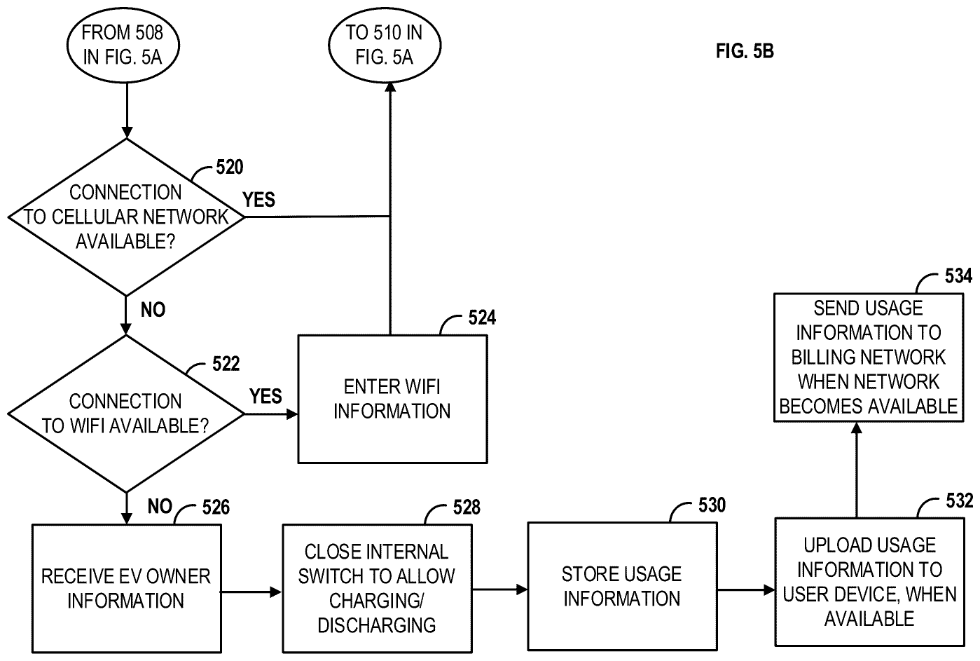

FIGS. 5A-5B show a flowchart of an example method 500 for charging or discharging a battery of an EV via a smart outlet 150 of a service location associated with a service owner. The method 500 may be implemented in whole or in part by a user device (e.g., device 120, mobile device, tablet, smartphone, etc.), and/or any other suitable computing device. The process may start at 502 by the service owner. At 504, the service owner may enter his/her user/customer information via the user device. It is determined whether a connection to the smart meter 140 is available at 506, whether a connection to a smart grid mesh network is available at 508, or whether a connection to a cellular network is available at 520. If a connection to the smart meter 140 is available at 506, a connection to the smart grid mesh network is available at 508, or a connection to the cellular network is available at 520, the YES branch may be followed to 510. At 510, it is determined whether a NFC scan is received from the EV owner. For example, the NFC scan may be received from a key fob, mobile device, or a smart phone of the EV owner. The NFC scan may comprise user information associated with the EV owner. If the NFC scan is received, the YES branch may be followed to 512. At 512, it is determined whether the NFC scan is associated with a valid account. If it is determined that the NFC scan is associated with a valid account, the YES branch may be followed to 514. At 514, an internal switch of the smart outlet 150 is closed to commence charging a battery of the EV. In an example, at 514, the smart outlet 150 may commence discharging the battery of the EV and provide the energy discharged from the battery to a utility grid. At 518, usage information associated with the amount of energy consumed to charge the battery, or the amount of energy discharged from the battery, may be uploaded to the billing network.

Returning to 510, if a NFC scan is not received, the NO branch may be followed to 516. At 516, the billing system sends a request for use of the smart outlet 150 and the branch may proceed to 514. Returning to 512, if the NFC scan is not associated with a valid account, the NO branch may be followed to 516. At 514, an internal switch of the smart outlet 150 is closed to commence charging or discharging a battery of the EV. At 518, usage information associated with the amount of energy consumed to charge the battery, or the amount of energy discharged from the battery, may be uploaded to the billing network.

Returning to 520, if a connection to the cellular network is not available, the NO branch may be followed to 522. At 522, it is determined whether a WiFi connection is available. If a WiFi connection is available, the YES branch may be followed to 524. At 524, WiFi credentials may be entered and the branch may be followed to 510.

Returning to 522, if a WiFi connection is unavailable, the NO branch may be followed to 526. At 526, EV owner billing information may be received via a NFC or a Bluetooth connection. At 528, an internal switch of the smart outlet 150 is closed to commence charging or discharging the battery of the EV. At 530, usage information associated with the amount of energy consumed to charge the battery, or the amount of energy discharged from the battery, is stored, at the smart outlet 150, for example. At 532, the usage information is uploaded to the user device when a connection to the user device becomes available. At 534, the usage information is sent to the billing network when a network service becomes available. The usage information may be used to debit a user account associated with the EV and/or debit a user account associated with the service owner. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

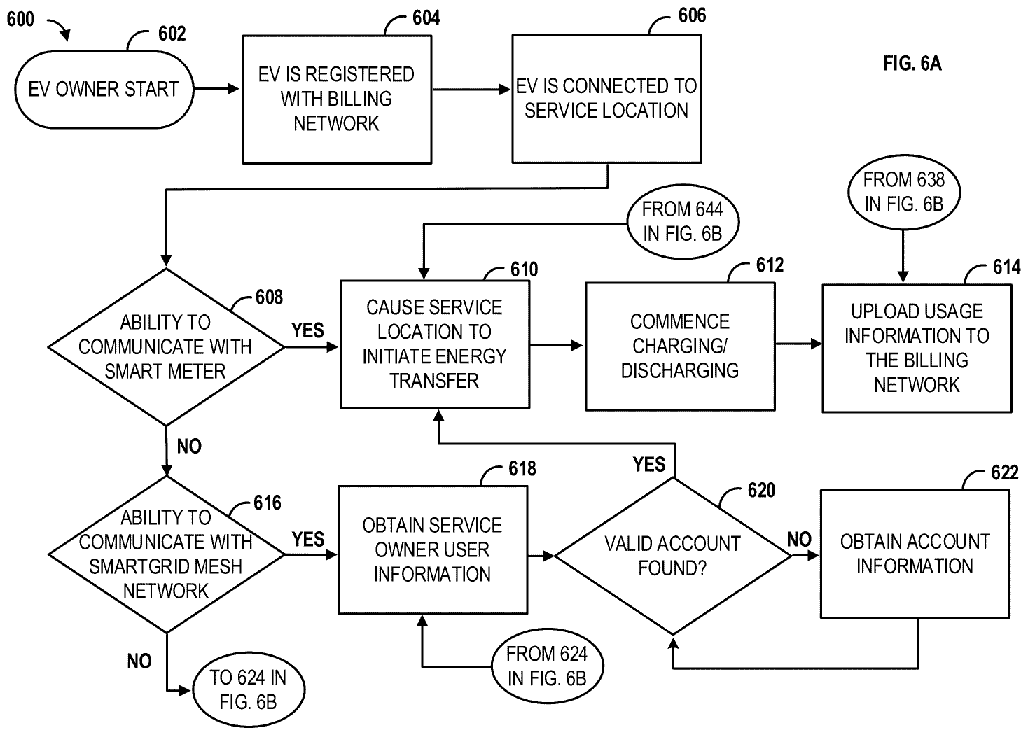

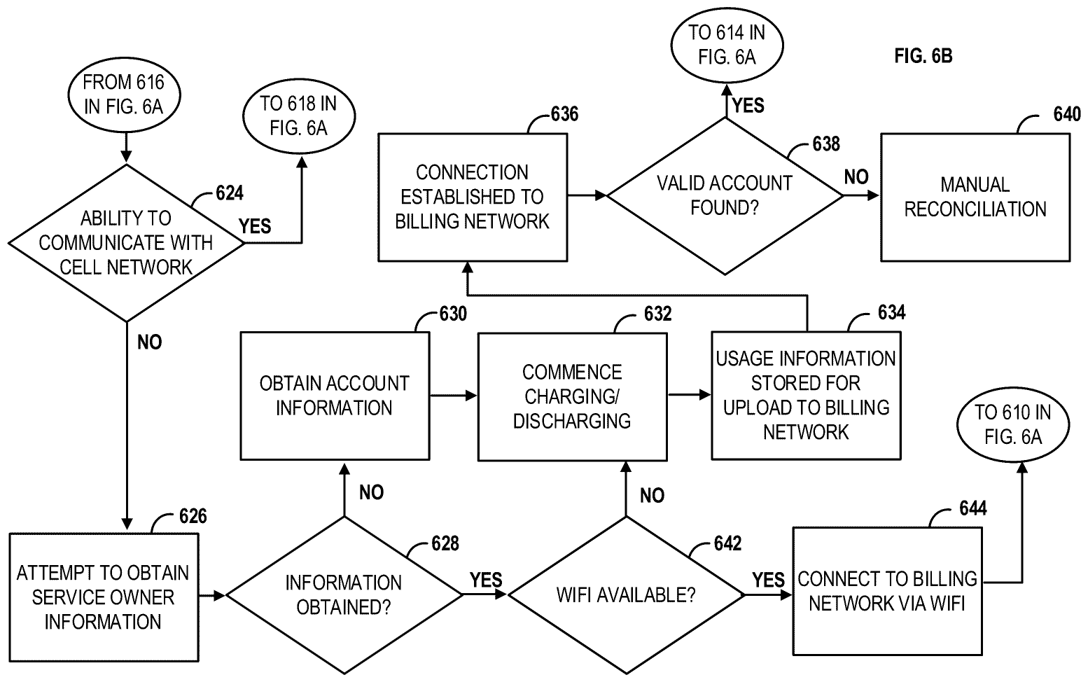

FIGS. 6A-6B show a flowchart of an example method 600 for charging or discharging a battery of an unmanned EV. The method 600 may be implemented in whole or in part by the unmanned EV, any other suitable computing device, and/or any combination thereof. The process may start at 602 by an owner of the EV. At 604, the owner of the unmanned EV may register the unmanned EV with the billing network. For example, the owner of the unmanned EV may provide user information associated with the unmanned EV, or the owner of the unmanned EV, such as account information or an identifier of the unmanned EV, or the owner of the unmanned EV. At 606, the unmanned EV may be connected to the service location. In one example, a smart adapter 110 may be connected to the unmanned EV (e.g., manually connected by an individual located at the service location) to connect the unmanned EV to a smart outlet 150 of the service location via the smart adapter 110. In another example, the unamend EV may establish a wireless charging connection, or a contact charging connection, with a charging station of the service location. At 608, a determination is made as to whether the unmanned EV, or the smart adapter 110, can communicate with a smart meter 140 associated with the service location. In one example, if the unmanned EV is connected to the secure outlet 150 via the smart adapter 110, a power line carrier coupling the smart outlet 150 with the smart meter 140 may be used by the smart adapter 110 to communicate with the unmanned EV, or the smart adapter 110, for example. In another example, the unmanned EV may communicate with the service location, or a computing device of the service location, via a wireless connection. If the unmanned EV, or the smart adapter 110, can communicate with the smart meter 140, the YES branch may be followed to 610. At 610, the service location may or may be caused, to initiate an energy transfer process (e.g., charging/discharging) between the unmanned EV and the service location. In one example, if the unmanned EV is connected to the secure outlet 150 via the smart adapter 110, the secure outlet 150 may close an internal switch of the secure outlet 150. In another example, if the unmanned EV is connected to the service location via wireless/contact charging, the service location may commence the energy transfer. At 612, the service location and/or smart outlet 150 may commence charging or discharging a battery of the unmanned EV. Once the charging/discharging process is complete, usage information associated with the amount of energy used to charge the battery of the unmanned EV or the amount of energy discharged from the battery of the unmanned EV may be uploaded to the billing network at 414.

Returning to 608, if the unmanned EV, or the smart adapter 110, cannot communicate with the smart meter 140, the NO branch may be followed to 616 or to 624. At 616, it is determined whether the unmanned EV, or the smart adapter 110, can communicate with a smart grid mesh network. At 624, it is determined whether the unmanned EV, or the smart adapter 110, can communicate with a cellular network. If the unmanned EV, or the smart adapter 110, can communicate with the smart grid mesh network or the unmanned EV, or the smart adapter 110, can communicate with the cellular network, the YES branch may be followed to 618. At 618, user information associated with the service owner may be received. For example, the unmanned EV may receive the service owner user information. At 620, it may be determined whether the service owner user information is associated with a valid user account. For example, the service owner user information may be sent to the billing network, wherein the billing network may provide a response indicating whether the user information is a valid user account. If the service owner user information is associated with a valid account, the YES branch may be followed to 610. If the service owner user information is not associated with a valid account, the NO branch may be followed to 622. At 622, the unmanned EV may obtain account information (e.g., account number, GPS coordinates of the service location, or the service location address) associated the service location (or utility provider associated with the service location) and the branch may proceed to 610. For an example, the service location may be configured to store the account information in the event an unmanned EV attempts to charge or discharge the battery of the unmanned EV at the service location. At 610, the service location may or may be caused, to initiate an energy transfer process (e.g., charging/discharging the battery) between the unmanned EV and the service location. At 612, the service location and/or smart outlet 150 may commence charging or discharging a battery of the unmanned EV. Once the charging/discharging process is complete, usage information associated with the amount of energy used to charge the battery or the amount of energy discharged from the battery may be uploaded to the billing network at 614.

Returning to 616/624, if the unmanned EV, or the smart adapter 110, cannot communicate with the smart grid mesh network at 616, or the unmanned EV, or the smart adapter 110, cannot communicate with the cellular network at 624, the NO branch may be followed to 626. At 626, the unmanned EV, or the smart adapter 110, may attempt to obtain user information associated with the service owner service location via short-range communication (e.g., Bluetooth, NFC, etc.). At 628, it is determined whether the service owner user information was obtained. If the service owner user information was not obtained, the NO branch may be followed to 630. At 630, the unmanned EV may obtain account information (e.g., account number, GPS coordinates of the service location, or the service location address) associated the service location (or utility provider associated with the service location). The branch may proceed to 632, wherein the service location and/or smart outlet 150 may commence charging or discharging a battery of the unmanned EV. At 634, the usage information associated with the amount of energy consumed to charge the battery or the amount of energy discharged from the battery may be stored for upload to the billing network when a wireless network service becomes available. At 636, a wireless network service may become available and a connection may be established with the billing service via the wireless network service. At 638, it is determined whether the usage information is associated with a valid account. If the usage information is associated with a valid account, the YES branch may be followed to 614, wherein the usage information may be uploaded to the billing network. If the usage information is not associated with a valid user account, the NO branch may be followed to 640. At 640, a manual reconciliation process may be performed via a utility customer service.

Returning to 628, if the service owner user information was obtained, the YES branch may be followed to 642. At 642, it is determined whether a WiFi connection is available at the service location. If it is determined that a WiFi connection is not available, the NO branch may be followed to 632. Returning to 642, if it is determined a WiFi connection is available, the YES branch may be followed to 644. At 644, the unmanned EV may connect to the billing network via the WiFi connection and the branch may proceed to 610. At 610, the service location may or may be caused, to initiate an energy transfer process (e.g., charging/discharging the battery) between the unmanned EV and the service location. At 612, the service location and/or smart outlet 150 may commence charging or discharging a battery of the unmanned EV. Once the charging/discharging process is complete, usage information associated with the amount of energy used to charge the battery, or the amount of energy discharged from the battery, may be uploaded to the billing network at 614. The usage information may be used to debit a user account associated with the EV and/or debit a user account associated with the service owner. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

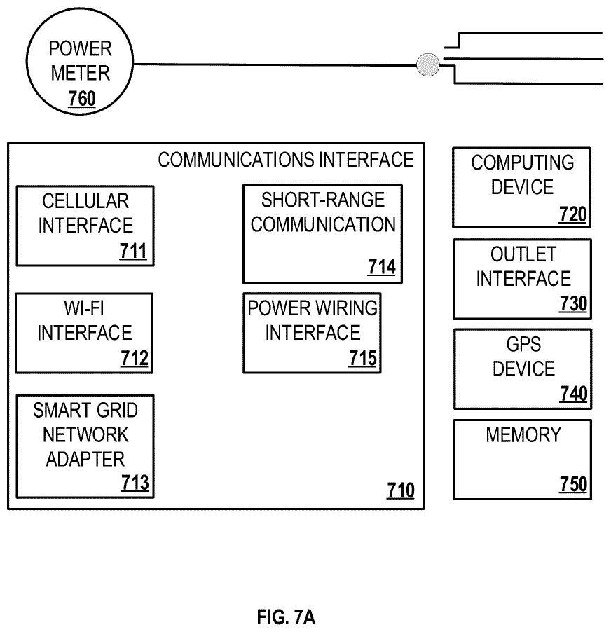

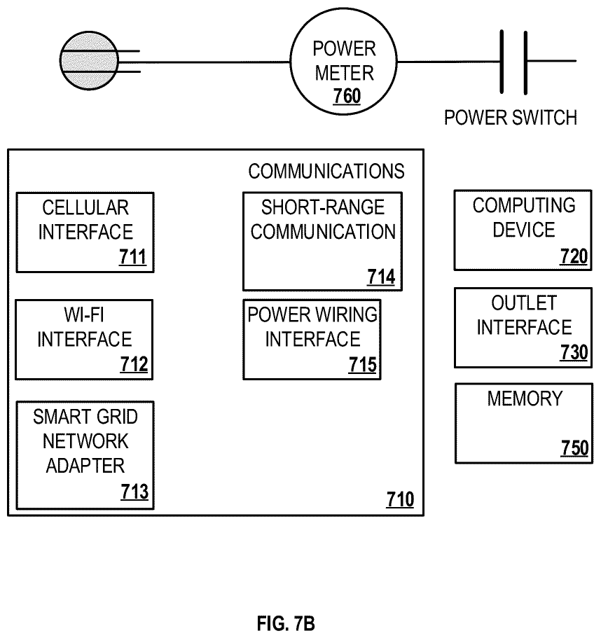

FIGS. 7A-7B show example configurations of a smart adapter 110 and/or a smart outlet 150. In an example, the smart adapter 110 may be configured to connect an EV to an outlet at a service location to charge, or discharge, a battery of the EV. In an example, the smart outlet 150 may be configured to engage an adapter of an EV to charge, or discharge a battery of the EV. The smart adapter 110 and/or the smart outlet 150 may comprise a communications interface 710, a computing device 720, an outlet interface 730, a GPS device 740, and memory 750. The communications interface 710 may comprise one or more of a cellular interface 711, a Wi-Fi interface 712, a smart grid mesh network adapter/interface 713, a short-range communication interface 714, or a power line carrier interface 715. The short-range communication interface 714 may comprise one or more of a Bluetooth interface or a near field communication (NFC) interface. In an example, the smart adapter 110 may be configured to engage an outlet (e.g., plug into the outlet) at a service location via the outlet interface 730. In an example, the smart outlet 150 may be configured to engage the adapter of the EV via the outlet interface 730. The computing device 720 may be configured to determine whether the smart adapter 110, or the smart outlet 150, may communicate with a billing network via the communications interface 710 based on the smart adapter 110 engaging with the smart outlet 150. For example, the computing device 720 may be configured to determine whether the smart adapter 110, or the smart outlet 150, may communicate with the billing network via one or more of the cellular interface 711, the Wi-Fi interface 712, the smart grid mesh network adapter/interface 713, the short-range communication interface 714, or the power line carrier interface 716. As an example, the computing device 720 may be configured to determine whether the smart adapter 110, or the smart outlet 150, may communicate with a power meter 760 via the power line carrier interface 715 via a power wiring of the smart outlet 150. The power meter 760 may be configured to determine information indicative of the amount of energy (e.g., watt-hours, kilowatt-hours,) used to charge the battery of the EV or the amount of energy discharged from the battery. As an example, the smart outlet 150 may be configured to communicate with the billing network via a Wi-Fi connection, wherein the smart outlet 150 may be configured to act as a Wi-Fi network gateway for the smart adapter 110. For example, the smart outlet 150 may be configured as a smart/secure outlet. The computing device 720 may be configured to determine whether the smart adapter 110 may communicate with the billing network via the Wi-Fi interface 712 via the smart outlet 150. The computing device 720 may be configured to determine location information of the service location based on information received from the GPS device 740. For example, the location information may be used to determine user information associated with a service owner of the service location or may be used to reconcile the service owner's account information offline. The service owner user information, user information associated with the EV, and usage information associated with an amount of energy used to charge the battery of the EV, or the amount of energy discharged from the battery, may be used to adjust the billing for both the service owner and the EV owner. For example, an account associated with the service owner may be credited based on the usage information and/or an account associated with the EV owner may be debited based on the usage information. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount. The smart adapter 110, and/or the smart outlet 150, may be configured to send the usage information to the billing network via the communications interface 710. In an example, if the computing device 720 determines that communication with the billing network via the communications interface 710 is unavailable, the computing device 720 may cause the usage information to be stored in memory 750 of the smart adapter 110 until communication with the billing network may be established. In an example, if the computing device 720 determines that communication with the billing network via the communications interface 710 is unavailable, the computing device 720 may cause the smart outlet 150 to send the usage information to a user device (e.g., device 120, a mobile device, a smartphone, a laptop device, a desktop, a tablet, etc.) to be stored in memory of the device until communication with the billing network may be established.

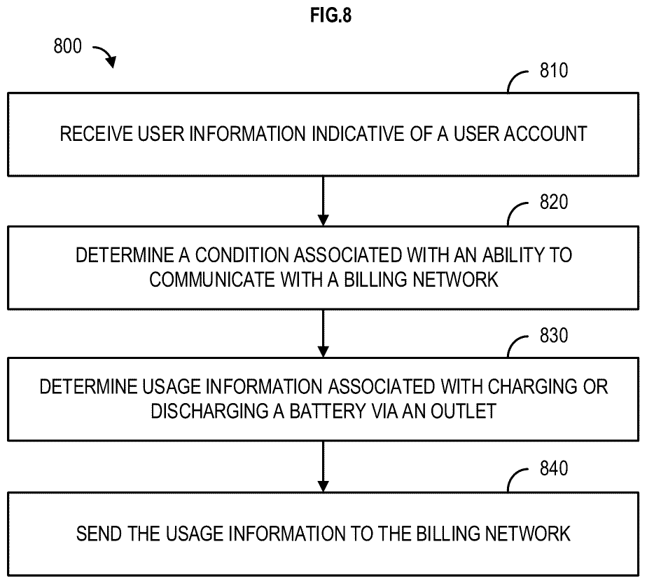

FIG. 8 shows a flowchart of an example method 800. The method 800 may be implemented in whole or in part by a user device (e.g., smart adapter 110). At step 810, user information indicative of a user account associated with the user device may be received. For example, the user device may comprise a smart adapter. The smart adapter may be configured to couple, or connect, an electric vehicle (EV) to an outlet associated with a service location associated with a service owner. In an example, the smart adapter may configured to engage 120 VAC or 240 VAC outlets. In an example, the user information may comprise one or more of user account information associated with an EV owner or identifier information associated with the EV owner.

At step 820, a condition associated with an ability to communicate with a billing network may be determined based on the user device engaging the outlet of the service owner. As an example, the condition may comprise whether the user device has the ability to communicate with a smart meter of the service owner. For example, the user device may be configured to communicate with the smart meter via a power line carrier that couples the outlet to the smart meter.

At step 830, usage information may be determined based on the user information and the condition. In one example, the usage information may be associated with charging a battery of the EV via the outlet. In another example, the usage information may be associated with discharging the battery of the EV via the outlet. For example, the usage information may comprise information indicative of an amount of energy used, or consumed, to charge the battery or an amount of energy discharged from the battery. In addition, the usage information may further comprise information indicative of the user account associated with the user device. As an example, the usage information may be determined based on satisfying the condition, wherein the condition may comprise the ability of the user device to communicate with a smart meter. For example, the outlet may commence charging or discharging the battery based on a determination that the user device has the ability to communicate with the smart meter. In one example, the usage information may be determined based on the user information and the amount of energy used during the charging of the battery. In another example, the usage information may be determined based on the user information and the amount of energy discharged from the battery.

As an example, an ability to communicate with a network may be determined based on not satisfying the condition. For example, the ability to communicate with the network may be determined based on the user device not being able to communicate with the smart meter. The network may comprise one or more of a smart grid mesh network, a cellular network, or a mobile network. The outlet may commence charging or discharging the battery based on the ability to communicate with the network. In one example, the usage information may be determined based on the user information and the amount of energy used during the charging of the battery. In another example, the usage information may be determined based on the user information and the amount of energy discharged from the battery. In an example, an override signal may be received that causes the device to discontinue discharging the battery and providing power to a utility grid. The override signal may be received from a utility provider associated with the utility grid. In an example, the charging or discharging of the battery may be initiated based on input received from the owner of the EV. For example, the owner may wish to only charge or discharge the battery at certain times of the day to efficiently manage the cost of charging the battery or manage the benefit associated with discharging the battery. For example, a utility provider may provide different energy costs, or benefits, during certain times of the day.

As an example, the outlet may commence charging or discharging the battery based on an account associated with the service owner of the outlet. For example, the account associated with the service owner may be identified based on the ability to communicate with the network.

At step 840, the usage information may be sent to the billing network. The user information associated with the user device and the amount of energy used to charge the battery, or the amount of energy discharged from the battery, may be further used to adjust the billing of the service owner of the outlet and the EV owner. As an example, a user account associated with the service owner may be credited an amount and/or a user account associated with the EV owner may be debited based on the usage information. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined cost amount.

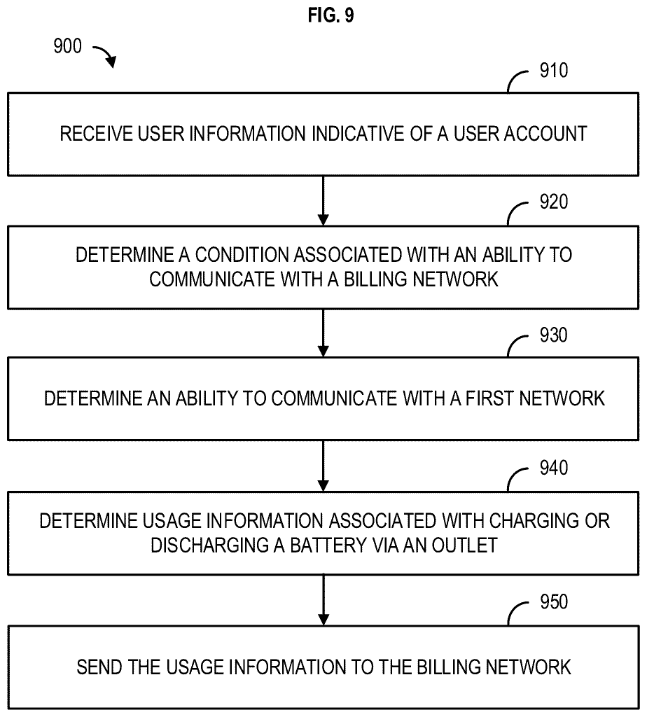

FIG. 9 shows a flowchart of an example method 900. The method 900 may be implemented in whole or in part by a user device (e.g., smart adapter 110). At step 910, user information indicative of a user account associated with the user device may be received. For example, the user device may comprise a smart adapter. The smart adapter may be configured to couple, or connect, an electric vehicle (EV) to an outlet associated with a service location associated with a service owner. In an example the smart adapter may configured to engage 120 VAC or 240 VAC outlets. In an example, the user information may comprise one or more of user account information associated with an EV owner or identifier information associated with the EV owner.

At step 920, a condition associated with an ability to communicate with a billing network may be determined based on the user device engaging the outlet of the service owner. As an example, the condition may comprise whether the user device has the ability to communicate with a smart meter of the service owner. For example, the user device may be configured to communicate with the smart meter via a power line carrier that couples the outlet to the smart meter.

At step 930, an ability to communicate with a first network may be determined based on not satisfying the condition. The first network may comprise a short-range communication network. For example, the short-range communication network may comprise one or more of a Bluetooth network or near-field communication (NFC) network. As an example, based on the user device not being able to communicate with the smart meter, a determination may be made that the user device may have the ability to communicate with the short-range communication network. As an example, the condition may further comprise whether the user device may communicate with a second network. The second network may comprise one or more of a smart grid mesh network, a cellular network, or a mobile network. For example, based on the user device not being able to communicate with the second network, a determination may be made that the user device may have the ability to communicate with the first network.

At step 940, usage information may be determined based on the user information and the ability to communicate with the first network. In one example, the usage information may be associated with charging a battery of the EV via the outlet. In another example, the usage information may be associated with discharging the battery of the EV via the outlet. For example, the usage information may comprise information indicative of an amount of energy used, or consumed, to charge the battery or an amount of energy discharged from the battery. In addition, the usage information may further comprise information indicative of the user account associated with the user device. As an example, a determination may be made that the outlet is capable of communicating with the billing network via a third network based on the user device being able to communicate with the first network. The third network may comprise a WiFi network. The outlet may commence charging or discharging a battery of the EV based on the outlet's ability to communicate with the billing network via the third network. In one example, the usage information may be determined based on the user information and the amount of energy used during the charging of the battery. In another example, the usage information may be determined based on the user information and the amount of energy discharged from the battery.

At step 950, the usage information may be sent to the billing network. The user information associated with the user device and the amount of energy used to charge the battery, or the amount of energy discharged from the battery, may be further used to adjust the billing of the service owner of the outlet and the EV owner. As an example, a user account associated with the service owner may be credited an amount and/or a user account associated with the EV owner may be debited based on the usage information. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

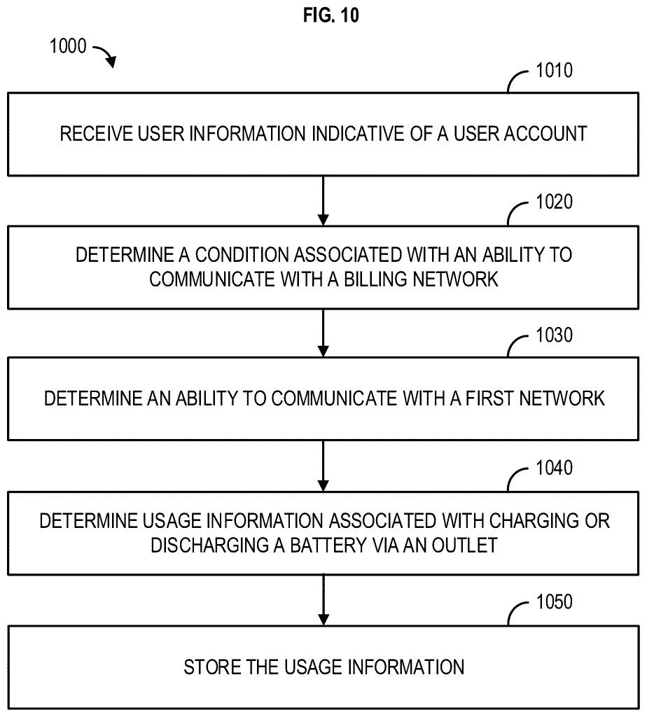

FIG. 10 shows a flowchart of an example method 1000. The method 1000 may be implemented in whole or in part by a user device (e.g., smart adapter 110). At step 1010, user information indicative of a user account associated with the user device may be received. For example, the user device may comprise a smart adapter. The smart adapter may be configured to couple, or connect, an electric vehicle (EV) to an outlet associated with a service location associated with a service owner. In an example, the smart adapter may configured to engage 120 VAC or 240 VAC outlets of the EV. In an example, the user information may comprise one or more of user account information associated with an EV owner or identifier information associated with the EV owner.

At step 1020, a condition associated with an ability to communicate with a billing network may be determined based on the user device engaging the outlet of the service owner. As an example, the condition may comprise whether the user device has the ability to communicate with a smart meter of the service owner. For example, the user device may be configured to communicate with the smart meter via a power line carrier that couples the outlet to the smart meter.

At step 1030, an ability to communicate with a first network may be determined based on not satisfying the condition. The first network may comprise a short-range communication network. For example, the short-range communication network may comprise one or more of a Bluetooth network or near-field communication (NFC) network. As an example, based on the user device not being able to communicate with the smart meter, a determination may be made that the user device may have the ability to communicate with the short-range communication network. As an example, the condition may comprise whether the user device may communicate with a second network. The second network may comprise one or more of a smart grid mesh network, a cellular network, or a mobile network. For example, based on the user device not being able to communicate with the second network, a determination may be made that the user device may have the ability to communicate with the first network.

At step 1040, usage information may be determined based on the user information and the ability to communicate with the first network. In one example, the usage information may be associated with charging a battery of the EV via the outlet. In another example, the usage information may be associated with discharging the battery of the EV via the outlet. For example, the usage information may comprise information indicative of an amount of energy used, or consumed, to charge the battery or an amount of energy discharged from the battery. In addition, the usage information may further comprise information indicative of the user account associated with the user device.

As an example, an account associated with a service owner of the outlet may be identified based on the ability to communicate with the first network. The outlet may commence charging or discharging a battery of the EV based on the account associated with the service owner being associated with a valid account. The usage information may be determined based on the user information and the amount of energy used during the charging of the battery or the amount of energy discharged from the battery.

As an example, a determination may be made that the outlet is not capable of communicating with the billing network via a third network based on the user device being able to communicate with the first network. The third network may comprise a WiFi network. The outlet may commence charging or discharging a battery of the EV based on the outlet's inability to communicate with the billing network via the third network. In one example, the usage information may be determined based on the user information and the amount of energy used during the charging of the battery. In another example, the usage information may be determined based on the user information and the amount of energy discharged from the battery.

At step 1050, the usage information may be stored, on the user device, for example. For example, the usage information may be stored for upload to the billing network when a wireless network service becomes available. An ability to communicate with the billing network may be determined based on a wireless network service becoming available. A status of an account associated with the service owner of the outlet may be determined based on the ability to communicate with the billing network via the wireless network service. As an example, if the account associated with the service owner is associated with a valid account, the stored usage information may be sent to the billing network. As an example, if the account associated with the service owner is not associated with a valid account, the stored usage information may be used for a manual reconciliation process via a utility customer service.

The user account information associated with the user device and the amount of energy used to charge the battery may be further used to adjust the billing of the service owner of the outlet and the EV owner. As an example, a user account associated with the service owner may be credited an amount and/or a user account associated with the EV owner may be debited based on the usage information. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

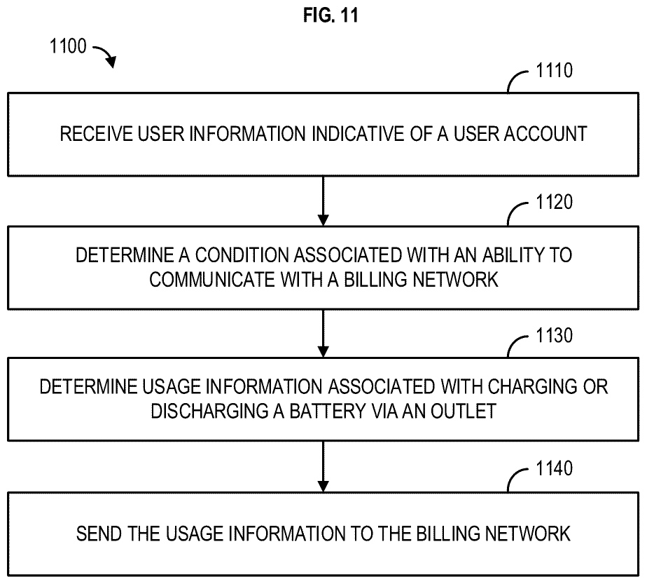

FIG. 11 shows a flowchart of an example method 1100. The method 1100 may be implemented in whole or in part by a computing device (e.g., device 120). As an example, the method 1000 may be associated with a smart outlet configured to charge or discharge a battery of an EV. At step 1110, user information indicative of a user account associated with the service location may be received. For example, the user account may be associated with a service owner, or the computing device, of the service location. The service location may include an outlet that may be configured to charge a battery of an electric vehicle (EV) via an adapter (e.g., smart adapter) coupled to the EV. The adapter may be configured to engage 120 VAC or 240 VAC outlets. The computing device may comprise one or more of a mobile device, a smartphone, a laptop device, a desktop, or a tablet. The user information may comprise one or more of user account information (e.g., billing information, address information, GPS coordinates, etc.) associated with the service owner or identifier information associated with the service owner.

At step 1120, a condition associated with an ability to communicate with a billing network may be determined. As an example, the condition may comprise an ability of the computing device to communicate with a smart meter or an ability of the computing device to communicate with a network. The network may comprise one or more of a smart grid mesh network, a mobile network, a cellular network, or a WiFi network.

At step 1130, usage information associated with charging or discharging a battery of the EV via an outlet may be determined based on the user information and the condition. The outlet may comprise a secure outlet (e.g., smart outlet). In one example, the usage information may comprise information indicative of an amount of energy used, or consumed, to charge the battery of the EV. In another example, the usage information may comprise information indicative of an amount of energy discharged from the battery of the EV. In addition, the usage information may further comprise information indicative of a user account associated with the smart adapter used to couple the EV to the outlet of the service owner. As an example, the usage information may be determined based on satisfying the condition. For example, a near field communication (NFC) scan may be received from a device of the EV owner based on determining the computing device is able to communicate with the smart meter or based on determining the computing device is able to communicate with the network. The device of the EV owner may comprise one or more of the EV, a key fob associated with the EV, a mobile device, a smartphone, or a smart adapter. The outlet may commence charging or discharging the battery based on receiving the NFC scan. In one example, the usage information may be determined based on user information and the amount of energy used during the charging of the battery. In another example, the usage information may be determined based on the user information and the amount of energy discharged from the battery.

As an example, the outlet may commence charging the battery based on an account associated with the EV owner. For example, an account associated with the EV owner may be identified based on receiving the NFC scan. In an example, the billing network may issue a request to use the outlet and commence the charging, or the discharging, process based on a status of the account associated with the EV owner indicating that the account is not valid.

At step 1140, the usage information may be sent to the billing network. The user information associated with the user device and the amount of energy used to charge the battery, or the amount of energy discharged from the battery, may be further used to adjust the billing of the service owner of the outlet and the EV owner. As an example, a user account associated with the service owner may be credited an amount and/or a user account associated with the EV owner may be debited based on the usage information. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

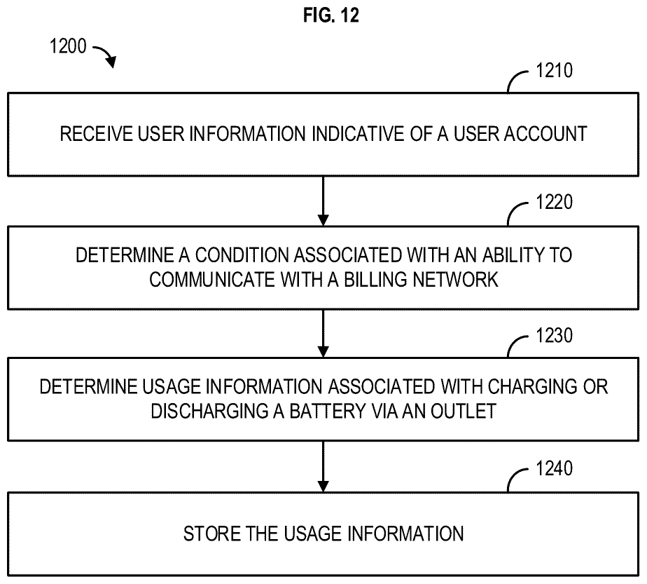

FIG. 12 shows a flowchart of an example method. The method 1200 may be implemented in whole or in part by a computing device (e.g., device 120). At step 1210, user information indicative of a user account associated with the service location may be received. For example, the user account may be associated with a service owner, or the computing device, of the service location. The service location may include an outlet that may be configured to charge a battery of an electric vehicle (EV) via an adapter (e.g., smart adapter) coupled to the EV. The adapter may be configured to engage 120 VAC or 240 VAC outlets. The computing device may comprise one or more of a mobile device, a smartphone, a laptop device, a desktop, or a tablet. The user information may comprise one or more of user account information (e.g., billing information, address information, GPS coordinates, etc.) associated with the service owner or identifier information associated with the service owner.

At step 1220, a condition associated with an ability to communicate with a billing network may be determined. As an example, the condition may comprise an ability of the computing device to communicate with a smart meter or an ability of the computing device to communicate with a network. The network may comprise one or more of a smart grid mesh network, a mobile network, a cellular network, or a WiFi network.

At step 1230, usage information associated with charging or discharging a battery of the EV via an outlet may be determined based on the user information and the condition. The outlet may comprise a smart outlet. In one example, the usage information may comprise information indicative of an amount of energy used, or consumed, to charge the battery of the EV. In another example, the usage information may comprise information indicative of an amount of energy discharged from the battery of the EV. In addition, the usage information may further comprise information indicative of a user account associated with the smart adapter used to couple the EV to the outlet of the service owner. As an example, the usage information may be determined based on not satisfying the condition. For example, the user information associated with the EV owner may be received from a device of the EV owner based on determining the computing device is not able to communicate with the smart meter or based on determining the computing device is not able to communicate with the network. The user information associated with the EV owner may comprise billing information of the EV owner or account information of the EV owner. The outlet may commence charging or discharging the battery based on receiving the user information associated with the EV owner. The user information may be received via a short-range communication network (e.g., a Bluetooth network or a NFC network). In one example, the usage information may be determined based on the user information associated with the EV owner and the amount of energy used during the charging of the battery. In another example, the usage information may be determined based on the user information and the amount of energy discharged from the battery.

At step 1240, the usage information may be stored for upload to the billing network when a wireless service becomes available. For example, the usage information may be stored on the outlet or smart adapter until communication may be established with the computing device. The usage information may be uploaded to the computing device once communication is established with the computing device. The usage information may be uploaded to the billing network when a wireless network service becomes available. The user information associated with the EV owner and the amount of energy used to charge the battery may be further used to adjust the billing of the service owner of the outlet and the EV owner. As an example, a user account associated with the service owner may be credited an amount based on the usage information. As an example, a user account associated with the EV owner may be debited an amount based on the usage information.

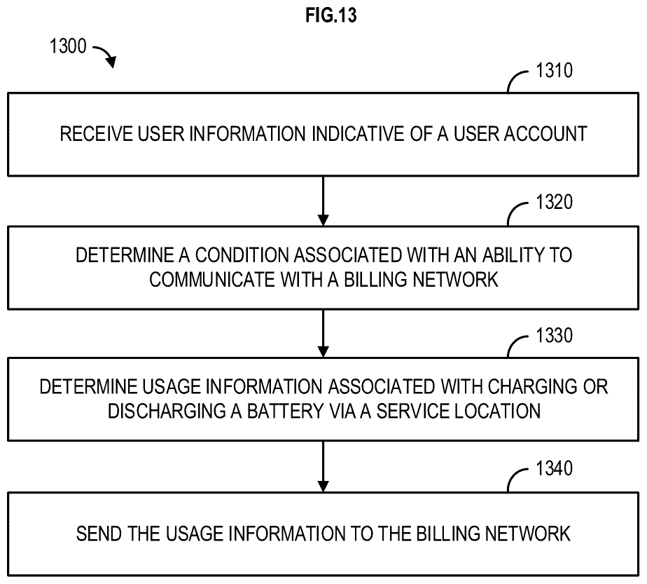

FIG. 13 shows a flowchart of an example method 1300. The method 1300 may be implemented in whole or in part by an unmanned electric vehicle (EV). At step 1310, user information indicative of a user account associated with the vehicle may be received. For example, the vehicle may comprise an unmanned EV. In an example, the vehicle may be configured to connect to an adapter (or a smart adapter) for engaging 120 VAC or 240 VAC outlets. In an example, the user information may comprise one or more of user account information associated with an owner of the unmanned EV or identifier information associated with the owner of the unmanned EV.

At step 1320, a condition associated with an ability to communicate with a billing network may be determined based on the vehicle connecting to a service location. As an example, the condition may comprise whether the vehicle has the ability to communicate with a smart meter of the service location. In one example, the vehicle may connect to the service location via an outlet of the service location, such as via an adapter connecting the vehicle to the outlet, for example. In another example, the vehicle may establish a wireless charging connection, or a contact charging connection, to a charging station of the service location.

At step 1330, usage information may be determined based on the user information and the condition. In one example, the usage information may be associated with charging a battery of the EV via the service location. In another example, the usage information may be associated with discharging the battery of the EV via the service location. For example, the usage information may comprise information indicative of an amount of energy used, or consumed, to charge the battery or an amount of energy discharged from the battery. In addition, the usage information may further comprise information indicative of the user account associated with the vehicle. As an example, the usage information may be determined based on satisfying the condition, wherein the condition may comprise the ability of the vehicle to communicate with a smart meter of the service location. For example, the service location may commence charging or discharging the battery based on a determination that the vehicle has the ability to communicate with the smart meter. In one example, the usage information may be determined based on the user information and the amount of energy used during the charging of the battery. In another example, the usage information may be determined based on the user information and the amount of energy discharged from the battery.

As an example, an ability to communicate with a network may be determined based on not satisfying the condition. For example, the ability to communicate with the network may be determined based on the vehicle not being able to communicate with the smart meter. The network may comprise one or more of a smart grid mesh network, a cellular network, or a mobile network. The service location may commence charging or discharging the battery based on the ability to communicate with the network. In one example, the usage information may be determined based on the user information and the amount of energy used during the charging of the battery. In another example, the usage information may be determined based on the user information and the amount of energy discharged from the battery. In an example, an override signal may be received that causes the vehicle, or the service location, to discontinue discharging the battery and providing power to a utility grid. The override signal may be received from a utility provider associated with the utility grid. In an example, the charging or discharging of the battery may be initiated based on input received from the owner of the unmanned EV. For example, the owner may wish to only charge or discharge the battery at certain times of the day to efficiently manage the cost of charging the battery or manage the benefit associated with discharging the battery. For example, a utility provider may provide different energy costs, or benefits, during certain times of the day.

As an example, the service location may commence charging or discharging the battery based on an account associated with the owner of the service location. For example, the account associated with the service location owner may be identified based on the ability to communicate with the network.

At step 1340, the usage information may be sent to the billing network. The user information associated with the vehicle and the amount of energy used to charge the battery, or the amount of energy discharged from the battery, may be further used to adjust the billing of the service location owner of the outlet and the owner of the unmanned EV. As an example, a user account associated with the service owner may be credited an amount and/or a user account associated with the owner of the unmanned EV may be debited based on the usage information. For example, a cost amount associated with the energy consumed to charge the battery of the unmanned EV may be determined and the user account associated with the owner of the unmanned EV may be debited and/or the account associated with the service location owner may be credited based on the determined cost amount. For example, a benefit amount associated with the energy discharged from the battery of the EV may be determined and the user account associated with the owner of the unmanned EV may be credited and/or the account associated with the service location owner may be debited based on the determined benefit amount.

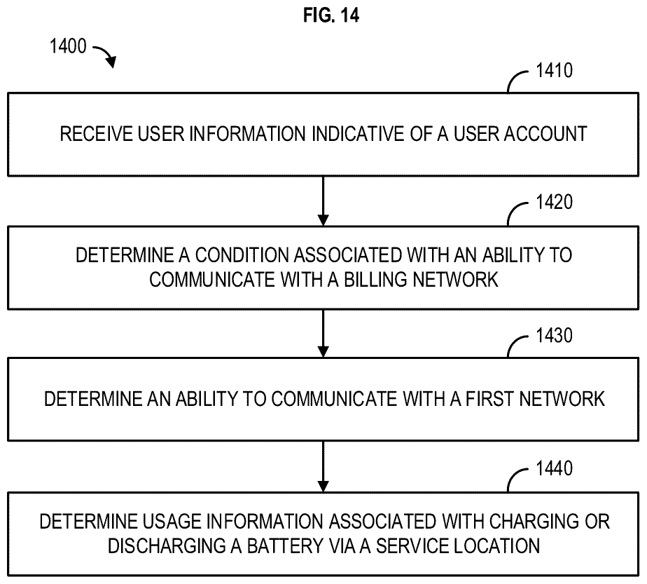

FIG. 14 shows a flowchart of an example method 1400. The method 1400 may be implemented in whole or in part by an unmanned electric vehicle (EV). At step 1410, user information indicative of a user account associated with the vehicle may be received. For example, the vehicle may comprise an unmanned EV. In an example, the vehicle may be configured to connect to an adapter (or a smart adapter) for engaging 120 VAC or 240 VAC outlets. In an example, the user information may comprise one or more of user account information associated with an owner of the unmanned EV or identifier information associated with the owner of the unmanned EV.

At step 1420, a condition associated with an ability to communicate with a billing network may be determined based on the vehicle connecting to a service location. As an example, the condition may comprise whether the vehicle has the ability to communicate with a smart meter of the service location or an ability to communicate with a network. The network may comprise one or more of a mesh network, a cellular network, or a mobile network. In one example, the vehicle may connect to the service location via an outlet of the service location, such as via an adapter connecting the vehicle to the outlet, for example. In another example, the vehicle may establish a wireless charging connection, or a contact charging connection, to a charging station of the service location.

At step 1430, an availability of user information of an owner of the service location may be determined based on not satisfying the condition. The service location owner user information may be obtained via a short-range communication network. The short-range communication network may comprise one or more of a Bluetooth network or near-field communication (NFC) network. As an example, based on the service location owner user information not being available, account information (e.g., account number, GPS coordinates of the service location, or the service location address) associated the service location (or utility provider associated with the service location) may be obtained. For an example, the service location may be configured to store the account information in the event an unmanned EV attempts to charge or discharge the battery of the unmanned EV at the service location.

At step 1440, usage information may be determined based on the user information and based on the availability of the service owner user information. In one example, the usage information may be associated with charging a battery of the EV via the outlet. In another example, the usage information may be associated with discharging the battery of the EV via the outlet. For example, the usage information may comprise information indicative of an amount of energy used, or consumed, to charge the battery or an amount of energy discharged from the battery. In addition, the usage information may further comprise information indicative of the user account associated with the user device.

As an example, a determination may be made that the service location is capable of communicating with the billing network via a network based on the availability of the service owner user information. The network may comprise a WiFi network. The service location may commence charging or discharging a battery of the EV based on the service location's ability to communicate with the billing network via the network. In one example, the usage information may be determined based on the user information and the amount of energy used during the charging of the battery. In another example, the usage information may be determined based on the user information and the amount of energy discharged from the battery.

As an example, the account information associated with the service owner may be identified based on the availability of the service owner user information. For example, if the service owner user information is not available, the account information may be identified. The service location may commence charging or discharging a battery of the EV based on the account information. In one example, the usage information may be determined based on the account information and the amount of energy used during the charging of the battery. In another example, the usage information may be determined based on the account information and the amount of energy discharged from the battery.

As an example, the usage information may be sent to the billing network or stored to be sent at a later time to the billing network. In an example, an ability to communicate with the billing network via a network service may be determined based on a network service becoming available. A status associated with an account associated with information associated with an owner of the service location may be determined based on the ability to communicate with the billing network via the network service. In one example, the stored usage information may be sent to the billing network based on the status indicating a valid account. In another example, a manual reconciliation of the stored usage information may be implemented (e.g., caused) via a utility customer service based on the status indicating an account that is not valid.

The user information associated with the user device and the amount of energy used to charge the battery, or the amount of energy discharged from the battery, may be further used to adjust the billing of the service owner of the outlet and the EV owner. As an example, a user account associated with the service owner may be credited an amount and/or a user account associated with the EV owner may be debited based on the usage information. For example, a cost amount associated with the energy consumed to charge the battery of the EV may be determined and the user account associated with the EV may be debited and/or the account associated with the service owner may be credited based on the determined cost amount. For example, a benefit amount associated with the energy discharged from the battery of the EV may be determined and the user account associated with the EV may be credited and/or the account associated with the service owner may be debited based on the determined benefit amount.

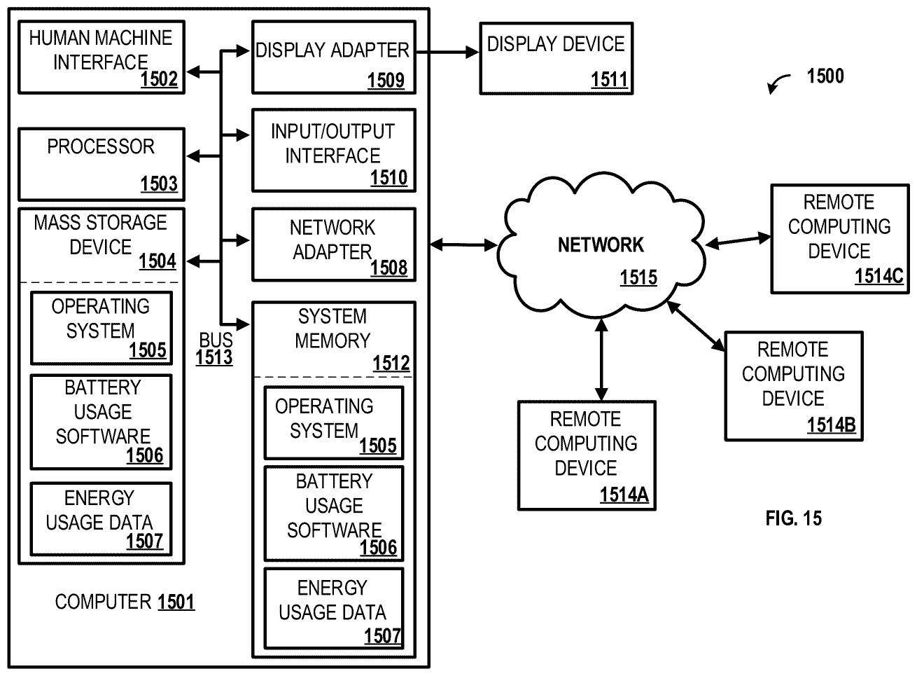

The methods and systems can be implemented on a computer 1501 as illustrated in FIG. 15 and described below. By way of example, the smart adapter 110, the device 120, the outlet 150 (e.g., secure outlet, smart outlet, etc.), and/or the computing device 160 of FIG. 1 can be a computer 1501 as illustrated in FIG. 15. Similarly, the methods and systems disclosed can utilize one or more computers to perform one or more functions in one or more locations. FIG. 15 is a block diagram illustrating an example operating environment 1500 for performing the disclosed methods. This example operating environment 1500 is only an example of an operating environment and is not intended to suggest any limitation as to the scope of use or functionality of operating environment architecture. Neither should the operating environment 1500 be interpreted as having any dependency or requirement relating to any one or combination of components illustrated in the example operating environment 1500.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1501. The computer 1501 can comprise one or more components, such as one or more processors 1503, a system memory 1512, and a bus 1513 that couples various components of the computer 1501 comprising the one or more processors 1503 to the system memory 1512. The system can utilize parallel computing.

The bus 1513 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1513, and all buses specified in this description can also be implemented over a wired or wireless network connection and one or more of the components of the computer 1501, such as the one or more processors 1503, a mass storage device 1504, an operating system 1505, battery usage software 1506, energy usage data 1507, a network adapter 1508, the system memory 1512, an Input/Output Interface 1510, a display adapter 1509, a display device 1511, and a human machine interface 1502, can be contained within one or more remote computing devices 1514A-1514C at physically separate locations, connected through buses of this form, in effect implementing a fully distributed system.

The computer 1501 typically comprises a variety of computer readable media. Examples of readable media can be any available media that is accessible by the computer 1501 and comprises, for example and not meant to be limiting, both volatile and non-volatile media, removable and non-removable media. The system memory 1512 can comprise computer readable media in the form of volatile memory, such as random access memory (RAM), and/or non-volatile memory, such as read only memory (ROM). The system memory 1212 typically can comprise data such as the energy usage data 1507 and/or program modules such as the operating system 1505 and the battery usage software 1506 that are accessible to and/or are operated on by the one or more processors 1503.

In an example, the computer 1501 can also comprise other removable/non-removable, volatile/non-volatile computer storage media. The mass storage device 1504 can provide non-volatile storage of computer code, computer readable instructions, data structures, program modules, and other data for the computer 1501. For example, the mass storage device 1504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1504, such as, by way of example, the operating system 1505 and the battery usage software 1506. One or more of the operating system 1505 and the battery usage software 1506 (or some combination thereof) can comprise elements of the programming and the battery usage software 1506. The energy usage data 1507 can also be stored on the mass storage device 1504. The energy usage data 1507 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1515.

In an example, the user can enter commands and information into the computer 1501 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1503 via the human machine interface 1502 that is coupled to the bus 1513, but can be connected by other interface and bus structures, such as a parallel port, game port, an IEEE 1394 Port (also known as a Firewire port), a serial port, a network adapter 1508, and/or a universal serial bus (USB).

In an example, the display device 1511 can also be connected to the bus 1513 via an interface, such as the display adapter 1509. It is contemplated that the computer 1501 can have more than one display adapter 1509 and the computer 1501 can have more than one display device 1511. For example, the display device 1511 can be a monitor, an LCD (Liquid Crystal Display), light emitting diode (LED) display, television, smart lens, smart glass, and/or a projector. In addition to the display device 1511, other output peripheral devices can comprise components such as speakers (not shown) and a printer (not shown) which can be connected to the computer 1501 via an Input/Output Interface 1510. Any step and/or result of the methods can be output in any form to an output device. Such output can be any form of visual representation, comprising, but not limited to, textual, graphical, animation, audio, tactile, and the like. The display device 1511 and the computer 1501 can be part of one device, or separate devices.

The computer 1501 can operate in a networked environment using logical connections to one or more remote computing devices 1514A-1514C. By way of example, a remote computing device 1514A-1514C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1501 and a remote computing device 1514A-1514C can be made via a network 1515, such as a local area network (LAN) and/or a general wide area network (WAN). Such network connections can be through the network adapter 1508. The network adapter 1508 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1505 are illustrated herein as discrete blocks, although it is recognized that such programs and components can reside at various times in different storage components of the computing device 1501, and are executed by the one or more processors 1503 of the computer 1501. An implementation of the battery usage software 1506 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
receiving, by a device, user information indicative of a user account associated with the device;
determining, based on the device engaging an outlet, a condition associated with an ability to communicate with a billing network;
determining, based on the user information and the condition, usage information associated with charging or discharging a battery via the outlet; and
sending the usage information to the billing network.

2. The method of claim 1, wherein the device comprises a smart adapter configured to connect an electric vehicle (EV) to the outlet to charge or discharge the battery.

3. The method of claim 1, wherein the condition comprises an ability to communicate with a smart meter via a power line carrier of the outlet.

4. The method of claim 1, wherein the usage information comprises information indicative of one or more of an amount of energy used to charge the battery and the user account associated with the device, or an amount of energy discharged from the battery and the user account associated with the device.

5. The method of claim 1, wherein determining, based on the user information and the condition, the usage information associated with the charging or the discharging of the battery associated with the user account via the outlet comprises:
initiating, based on satisfying the condition, charging or discharging of the battery via the outlet; and
determining, based on the user information and an amount of energy used during the charging or the discharging of the battery, the usage information.

6. The method of claim 1, wherein determining, based on the user information and the condition, the usage information associated with the charging or the discharging the battery associated with the user account via the outlet comprises:
determining, based on not satisfying the condition, an ability to communicate with a network;
initiating, based on the ability to communicate with the network, charging or discharging of the battery via the outlet; and
determining, based on the user information and an amount of energy used during the charging or the discharging of the battery, the usage information.

7. The method of claim 6, wherein the network comprises one or more of a mesh network, a cellular network, or a mobile network.

8. The method of claim 1, further comprising one or more of: debiting the user account based on the usage information or crediting an account associated with an owner of the outlet based on the usage information.

9. A method comprising:
receiving, by a device, user information indicative of a user account associated with the device;
determining, based on the device engaging an outlet, a condition associated with an ability to communicate with a billing network;
determining, based not satisfying the condition, an ability to communicate with a first network; and
determining, based on the user information and the ability to communicate with the first network, usage information associated with charging or discharging a battery via the outlet.

10. The method of claim 9, wherein the condition comprises one of an ability to communicate with a smart meter via a power line carrier of the smart meter, or an ability to communicate with a second network comprising one or more of a mesh network, a cellular network, or a mobile network.

11. The method of claim 9, wherein the first network comprises one or more of a Bluetooth network or a near field communication (NFC) network.

12. The method of claim 9, wherein determining, based on the user information and the ability to communicate with the outlet via the first network, the usage information associated with the charging or the discharging of the battery via the outlet comprises:
determining, based on the ability to communicate with the first network, a capability of the outlet being able to communicate with the billing network via a second network comprising a WiFi network;
initiating, based on the outlet capable of communicating with the billing network via the second network, charging or discharging of the battery via the outlet; and
determining, based on the user information and an amount of energy used during the charging or the discharging of the battery, the usage information.

13. The method of claim 9, wherein determining, based on the user information and the ability to communicate with the outlet via the first network, the usage information associated with the charging or the discharging of the battery via the outlet comprises:
identifying, based on the ability to communicate with the first network, an account associated with an owner of the outlet;
initiating, based on the account associated with the owner of the outlet not being a valid account, charging or discharging of the battery via the outlet; and
determining, based on the user information and an amount of energy used during the charging or the discharging of the battery, the usage information.

14. The method of claim 9, wherein the usage information comprises information indicative of one or more of an amount of energy used to charge the battery and the user account associated with the device, or an amount of energy discharged by the battery and the user account associated with the device.

15. The method of claim 9, further comprising one or more of:
sending the usage information to the billing network; or
storing the usage information.

16. The method of claim 9, further comprising one or more of: debiting the user account based on the usage information or crediting an account associated with an owner of the outlet based on the usage information.

17. An apparatus comprising:
an outlet interface, wherein the outlet interface is configured to engage an outlet associated with a service location;
a communications interface, wherein the communications interface comprises one or more of a power line carrier interface, a cellular network interface, a WiFi network interface, a smart grid network interface, or a short-range communication interface; and
a computing device in communication with the outlet interface and the communications interface, wherein the computing device is configured to:
determine, based on the outlet interface engaging the outlet, a condition associated with an ability of the communications interface to communicate with a billing network;
determine, based on the condition, usage information associated with charging or discharging a battery via the outlet; and
send the usage information to the billing network.

18. The apparatus of claim 17, wherein the apparatus comprises a smart adapter, wherein the smart adapter is configured to couple an electric vehicle (EV) to the outlet to charge or discharge the battery, and wherein the outlet comprises one or more of a 120 VAC outlet or a 240 VAC outlet.

19. The apparatus of claim 17, wherein the short-range communication interface comprises one or more of a Bluetooth interface or a near field communication (NFC) interface.

20. The apparatus of claim 17, wherein the condition comprises one or more of an ability of the communications interface to communicate with a smart meter via the power line carrier interface via a power wiring of the outlet, an ability of the communications interface to communicate with a mesh network via the smart grid network interface, an ability of the communications interface to communicate with a cellular network via the cellular network interface, an ability of the communications interface to communicate with the outlet via the WiFi network interface.
